(19) United States
(12) Patent Application Publication
(10) Pub. No.: US 2025/0246616 A1
(43) Pub. Date: Jul. 31, 2025

(54) CATHODE MATERIALS HAVING OXIDE SURFACE SPECIES

(71) Applicant: QUANTUMSCAPE BATTERY, INC., San Jose, CA (US)

(72) Inventors: Cheng-Chieh CHAO, San Jose, CA (US); Sarah CHAVEZ, San Jose, CA (US); Hyeseung CHUNG, San Jose, CA (US); Seitaro ITO, San Jose, CA (US); Yuki KATOH, San Jose, CA (US); Lokshin KONSTANTIN, San Jose, CA (US); Akinari OHASHI, San Jose, CA (US); Jessa SILVER, San Jose, CA (US); Yaosen TIAN, San Jose, CA (US); Virgil XU, San Jose, CA (US); Zhenfeng YU, San Jose, CA (US)

(21) Appl. No.: 18/703,174

(22) PCT Filed: Dec. 15, 2022
(86) PCT No.: PCT/US2022/053080

§ 371 Date: Apr. 19, 2024

Related U.S. Application Data
(60) Provisional application No. 63/291,209, filed on Dec. 17, 2021.
(60) Provisional application No. 63/299,732, filed on Jan. 14, 2022.

(51) Int. Cl. H01M 4/525; H01M 4/02; H01M 4/04; H01M 4/36; H01M 4/505

(52) U.S. Cl. CPC H01M 4/525; H01M 4/0471; H01M 4/366; H01M 4/505; H01M 2004/021; H01M 2004/028

(57) ABSTRACT

The present disclosure concerns lithium zirconium phosphate (LZP) chemical oxides for coated cathode active materials, which are useful in cathodes (i.e., positive electrodes) of rechargeable lithium-batteries for reversibly storing lithium ions (Li⁺).

### FIELD

The present disclosure concerns chemical oxides for coated cathode active materials, which are useful in cathodes (i.e., positive electrodes) of rechargeable lithium-batteries for reversibly storing lithium ions (Li⁺).

### BACKGROUND

There is currently an unmet need in the rechargeable lithium battery field directed to cathode active materials which are stable at high voltage (e.g., 4.2 V versus lithium metal) and/or high temperature (e.g., 60° C.). The instability tends to result in increases in internal resistance in the battery, when the battery is stored or when the battery is used, or both.

Solid electrolyte materials tend not to be stable at high voltage or high temperature. Solid electrolyte materials may react with cathode active materials. Cathode active materials may also oxidize when exposed to high voltage or high temperature. These are a few of the reasons for battery performance degradation. Some researchers have tried to coat cathode active materials with LiNbO₃, Li₂ZrO₃, and LiTaO₃ to prevent this oxidative. See for example, US 2016/0156021 A1; US 2019/0044146 A1; and U.S. Pat. No. 9,692,041 B2. See also Chem. Mater. 2018, 30, 22, 8190-8200, (doi.org/10.1021/acs.chemmater.8b03321); Adv. Energy Mater. 2020, 10, 1903778 (doi.org/10.1002/aenm.201903778); and Journal of Power Sources Volume 248, 15 Feb. 2014, Pages 943-950, (doi.org/10.1016/j.jpowsour.2013.10.005). However, these previously reported coatings had poor stability and/or suffered from other disadvantages. For example, at potentials as high as 4.2V (vs Li/Li⁺), the internal resistance of these coatings increased rapidly when in a charged state. For these and other reasons, these previously reported coatings were inferior in several regards.

Set forth herein are solutions to this and other problems in the relevant field.

### SUMMARY

Set forth herein is a composition comprising: a cathode active material; and at least one oxide bonded to the cathode active material; wherein the at least one oxide bonded to the cathode active material comprises lithium (Li), oxygen (O), and, optionally zirconium (Zr) and phosphorus (P); wherein the molar ratios of Li, Zr, P, and O are represented by the formula LiₓZr_{y}PₐO_{d}, wherein 0.05≤x≤7.0, 0≤y≤3.0, 0≤a≤6.0; and 2.0≤d≤20.0; and wherein subscripts x, y, a, and d are selected so the at least one oxide is charge neutral.

In one embodiment, the composition comprises a cathode active material; and at least one oxide bonded to the cathode active material; wherein the at least one oxide bonded to the cathode active material comprises lithium (Li), oxygen (O), and at least one of zirconium (Zr) and phosphorus (P); wherein the molar ratios of Li, Zr, P, and O are represented by the formula LiₓZr_{y}PₐO_{d}, wherein 0.05≤x≤25.0, 0≤y≤5.0, 0≤a≤16.0; and 2.0≤d≤55.0; and wherein subscripts x, y, a, and d are selected so the at least one oxide is charge neutral and y and a are not both zero. In a further embodiment, the composition has a ratio of Zr:Ni, as measured by x-ray photoelectron spectroscopy (XPS) of 0.3 to 3.2. In one embodiment, the molar ratios of Li, Zr, P, and O are represented by the formula LiₓZr_{y}PₐO_{d}, wherein 0.05≤x≤7.0, 0≤y≤3.0, 0≤a≤6.0; and 2.0≤d≤20.0; and, wherein subscripts x, y, a, and d are selected so the at least one oxide is charge neutral and y and a are not both zero and the composition has a ratio of Zr:Ni, as measured by x-ray photoelectron spectroscopy (XPS) of 0.3 to 3.2.

Set forth herein is a composition comprising: a cathode active material; and an oxide bonded to the cathode active material, wherein: the oxide comprises a compound of the formula LiₓZr_{y}PₐO_{d}, wherein 0.05≤x≤8.0, 0≤y≤3.0, 0≤a≤6.0; and 2.0≤d≤20.0 and wherein the formula is charge neutral. In one embodiment, the oxide comprises a compound of the formula LiₓZr_{y}PₐO_{d}, wherein 0.05≤x≤1.5, 1.0≤y≤3.0, 1.0≤a≤6.0; and 2.0≤d≤20.0 and wherein the formula is charge neutral. In one embodiment, the oxide comprises a compound of the formula LiₓZr_{y}PₐO_{d}, wherein 20.0≤x≤25.0, 2.0≤y≤5.0, 10.0≤a≤16.0; and 50.0≤d≤55.0 and wherein the formula is charge neutral. In one embodiment, the oxide is amorphous based on x-ray diffraction pattern analysis. In one embodiment, the oxide comprises crystalline domains based on transmission electron microscopy (TEM) analysis. In certain embodiments, the oxide is selected from LiZr₂(PO₄)₃, Li₃PO₄, Li₂ZrO₃, Li₃ZrPO₆, Li₅PZrO₇, Li₇ZrPO₈, and combinations thereof. In other embodiments, the oxide is selected from LiZr₂(PO₄)₃, Li₃PO₄, Li₂ZrO₃, Li₃ZrPO₆, Li₅PZrO₇, Li₇ZrPO₈, Li₂₄Zr₃P₁₄O₅₃ and combinations thereof. In one embodiment, the oxide is selected from LiZr₂(PO₄)₃. In one embodiment, the oxide bonded to the cathode active material is a coating on the cathode active material.

Set forth herein is a composition comprising: a cathode active material; and an oxide bonded to the cathode active material, wherein: the oxide comprises LiZr₂(PO₄)₃ and wherein the cathode active material comprises less than about 10 weight % of lithium, less than about 1.0 weight % of zirconium, less than about 0.5 weight % of phosphorus, and about 60 weight % of manganese, cobalt, and nickel combined as measured by inductively coupled plasma (ICP); and wherein the atomic percent ratio of Zr:Ni is about 0.55 as measured by X-ray photoelectron spectroscopy (XPS). Also set forth herein is a composition comprising: a cathode active material; and an oxide bonded to the cathode active material, wherein: the oxide comprises LiZr₂(PO₄)₃ and wherein the atomic percent ratio of Zr:Ni is about 0.75 as measured by X-ray photoelectron spectroscopy (XPS).

Also set forth herein is a composition comprising: a cathode active material having a surface and an oxide on the surface wherein the oxide is selected from the group consisting of amorphous lithium zirconium oxide; amorphous lithium zirconium phosphorus oxide; and combinations thereof; wherein the composition has a ratio of Zr:Ni, as measured by x-ray photoelectron spectroscopy (XPS) of 0.3 to 3.2. In one embodiment, the composition comprises a cathode active material having a surface and an oxide on the surface wherein the oxide is selected from the group consisting of LiZr₂(PO₄)₃, Li₂ZrO₃, Li₃ZrPO₆, Li₅PZrO₇, Li₇ZrPO₈, Li₂₄Zr₃P₁₄O₅₃. and combinations thereof; wherein the composition has a ratio of Zr:Ni, as measured by x-ray photoelectron spectroscopy (XPS) of 0.3 to 3.2.

Set forth herein is an oxide having the following formula, LiₓZr_{y}PₐO_{d}, wherein 0.05≤x≤25.0, 0≤y≤5.0, 0≤a≤16.0; and 2.0≤d≤55.0 and wherein the formula is charge neutral, and wherein the compound is bonded to cathode active material selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1. In one embodiment, the oxide has the following formula, LiₓZr_{y}PₐO_{d}, wherein 0.05≤x≤8.0, 0≤y≤3.0, 0≤a≤6.0; and 2.0≤d≤20.0 and the formula is charge neutral, and the compound is bonded to cathode active material selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1. In certain embodiments, the cathode active material is selected from lithium cobalt oxide (LCO), lithium nickel cobalt aluminum oxide (NCA), lithium nickel manganese cobalt oxide (NMC), lithium iron phosphate (LFP), and combinations thereof. In one embodiment, the cathode active material is lithium nickel manganese cobalt oxide (NMC). In alternative embodiments, the cathode active material is a member selected from the NMC class of cathode active materials; LFP class of cathode active materials; LNMO class of cathode active materials; NCA class of cathode active materials; LMO class of cathode active materials; and, LCO class of cathode active materials.

Set forth herein is also a solid-state battery comprising 1) cathode active material selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1; 2) an oxide bonded to the cathode active material, wherein: the oxide comprises a compound of the formula LiₓZr_{y}PₐO_{d}, wherein 0.05≤x≤25.0, 0≤y≤5.0, 0≤a≤16.0; and 2.0≤d≤55.0 and wherein the formula is charge neutral; 3) a solid-state electrolyte; and, 4) an anode active material selected from lithium metal, lithium titanate (Li₂TiO₃, LTO), carbon/graphite (C), silicon (Si)/silicon oxide (SiOₓ), lithium (Li), zinc (Zn), aluminum (Al), magnesium (Mg), alloys thereof, and combinations thereof.

In one embodiment, the solid-state battery comprises 1) cathode active material selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+2=1, and 0≤x≤1, 0≤y≤1, and 0≤z≤1; 2) an oxide bonded to the cathode active material, wherein: the oxide comprises a compound of the formula LiₓZr_{y}PₐO_{d}, wherein 0.05≤x≤7.0, 0≤y≤3.0, 0≤a≤6.0; and 2.0≤d≤20.0 and wherein the formula is charge neutral; 3) a solid-state electrolyte; and, 4) an anode active material selected from lithium metal, lithium titanate (Li₂TiO₃, LTO), carbon/graphite (C), silicon (Si)/silicon oxide (SiOₓ), lithium (Li), zinc (Zn), aluminum (Al), magnesium (Mg), alloys thereof, and combinations thereof.

Also set forth herein is a process for making a coated cathode active material wherein an oxide comprising a compound of the formula LiₓZr_{y}PₐO_{d} is bonded to the cathode active material, wherein 0.05≤x≤25.0, 0≤y≤5.0, 0≤a≤16.0; and 2.0≤d≤55.0 and wherein the formula is charge neutral; comprising the following steps: 1) coating a cathode active material with a solution of a) LiOH and b) a zirconium precursor and/or a phosphorus precursor; 2) removing the solvent from the solution to provide a cathode active material bonded to the oxide of formula LiₓZr_{y}PₐO_{d}; and, 3) heating the cathode active material under dry air conditions to form a coated cathode active material. In one embodiment, the zirconium precursor is Zr(OBu)₄. In one embodiment, the phosphorus precursor is P₂O₅. In one embodiment, the process for making a coated cathode active material wherein an oxide comprises a compound of the formula LiₓZr_{y}PₐO_{d} bonded to the cathode active material, wherein 0.05≤x≤8.0, 0≤y≤3.0, 0≤a≤6.0; and 2.0≤d≤0.0 and wherein the formula is charge neutral; comprises the following steps: 1) coating a cathode active material with a solution of a) LiOH and b) a zirconium precursor and/or a phosphorus precursor; 2) removing the solvent from the solution to provide a cathode active material bonded to the oxide of formula LiₓZr_{y}PₐO_{d}; and, 3) heating the cathode active material under dry air conditions to form a coated cathode active material. In one embodiment, the zirconium precursor is Zr(OBu)₄. In one embodiment, the phosphorus precursor is P₂O₅.

### BRIEF DESCRIPTION OF FIGURES

FIG. 1 is a schematic of the spray coating process, one non-limiting method for producing the coated active materials described herein.

FIG. 2 is a transmission electron microscopy (TEM) image of an NMC coated with LiZr₂(PO₄)₃. The LiZr₂(PO₄)₃ coating has a thickness of about 2.0 nm to 2.5 nm. The scale of the image (5 nm) is shown in the bottom left.

FIG. 3 is a TEM image of an NMC coated with LiZr₂(PO₄)₃. The LiZr₂(PO₄)₃ coating is amorphous, as determined by TEM. The scale of the image (10 nm) is shown in the bottom left.

FIG. 4 is a TEM image of an NMC coated with LiZr₂(PO₄)₃. The LiZr₂(PO₄)₃coating comprises crystalline domains and amorphous domains, as determined by TEM. The crystalline domain is at the interface of the cathode active material. The scale of the image (10 nm) is shown in the bottom left.

FIG. 5 is a TEM image of an NMC coated with LiZr₂(PO₄)₃. The LiZr₂(PO₄)₃coating comprises crystalline domains and amorphous domains. The crystalline domain is at the interface of the cathode active material and has a thickness between 1.7 nm and 2.2 nm, while the amorphous domain has a thickness of 3.4 nm. The scale of the image (5 nm) is shown in the bottom left.

FIG. 6 is a TEM image of an NMC coated with LiZr₂(PO₄)₃ where the coating is discontinuous. The scale of the image (20 nm) is shown in the bottom left.

### DETAILED DESCRIPTION

Set forth herein are oxides for cathode active materials wherein the oxide comprises a compound of the formula LiₓZr_{y}PₐO_{d}, wherein 0.05≤x≤8.0, 0≤y≤3.0, 0≤a≤6.0; and 2.0≤d≤20.0 and wherein the formula is charge neutral. Also set forth herein are oxides for cathode active materials wherein the oxide comprises a compound of the formula LiₓZr_{y}PₐO_{d}, wherein 0.05≤x≤25.0, 0≤y≤5.0, 0≤a≤16.0; and 2.0≤d≤55.0 and wherein the formula is charge neutral. In certain embodiments, the oxide is selected from LiZr₂(PO₄)₃, Li₃ZrPO₆, Li₅PZrO₇, and Li₇ZrPO₈. In certain embodiments, the oxide is Li₃PO₄ or Li₂ZrO₃. In one embodiment, the oxide is LiZr₂(PO₄)₃. In an alternative embodiment, the oxide is Li₂₄Zr₃P₁₄O₅₃. In certain embodiments, including any of the foregoing, the oxide is a coating on the cathode active material.

In one embodiment, the coating is a discontinuous layer. In one embodiment, the coating is a continuous layer. In one embodiment, the coating comprises crystalline domains as determined by TEM analysis. In one embodiment, the coating comprises amorphous domains as determined by TEM analysis. In one embodiment, the coating comprises crystalline domains and amorphous domains as determined by TEM analysis.

Certain of these oxides and coatings may prevent, or delay, the aforementioned oxidation reactions which were noted as a reason for battery performance degradation. When used in batteries, the newly disclosed coated cathode active materials set forth herein result in more stable batteries.

### Definitions

As used herein, the term “about,” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein the phrase “dry air,” refers to air with a reduced amount of humidity. Dry air may be supplied in a clean room. Dry air is characterized as having a dew point less than −70° C.

As used herein the phrase “cathode active material,” refers to a material which can intercalate lithium ions or react with lithium ions in a reversible manner. Examples include LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1. In these formula, x, y, and z are chosen so that the formula is charge neutral. Additional examples include a cathode active material selected from a member of the NMC class of cathode active materials (including, but not limited to, LiNiCoMnO₂); the LFP class of cathode active materials (including, but not limited to, LiFePO₄/C); the LNMO class of cathode active materials (including, but not limited to, LiNi_{0.5}Mn_{1.5}O₄); the NCA class of cathode active materials (inlcuding, but not limited to, LiMn₂O₄ and LiMn₂O₂); the LMO class of cathode active materials (including, but not limited to, LiMn₂O₄); the LCO class of cathode active materials (including, but not limited to, LiCoO₂), or any cathode active material described in Minnmann et al. Advanced Energy Materials, 2022, 12, 2201425).

As used herein the phrase “characterized as having an x-ray powder diffraction (XRD) pattern having peaks at least at,” means that when the material is analyzed using x-ray powder diffraction, according to the techniques in the Examples, the sample will be observed to have at least the recited XRD peaks and possibly other peaks. Peaks are places of high intensity in the XRD pattern which are indicative of d-spacing (lattice spacing) of the crystalline unit cell which is inducing the observed XRD pattern when x-rays are incident upon the material being analyzed by XRD.

As used herein the phrase “as measured by inductively coupled plasma (ICP) analysis” means that when the material is analyzed using ICP, according to the techniques in the Examples, the material will be observed to comprise the weight % of the recited element.

As used herein the phrase “as determined by XPS” means that when the material is analyzed by XPS as a loose powder, or X-ray photoelectron spectroscopy, according to the techniques in the Examples, the material will be observed to have the atomic percent ratio of clement to element or functional group to functional group on the surface of the sample.

As used herein the phrase “solid-state cathode refers to a cathode which does not include any liquid-phase electrolytes. As used herein, the terms “cathode” and “anode” refer to the electrodes of a battery. The cathode and anode are often referred to in the relevant field as the positive electrode and negative electrode, respectively. During a charge cycle in a Li-secondary battery, Li ions leave the cathode and move through an electrolyte, to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode. As used herein, the phrase “positive electrode” refers to the electrode in a secondary battery towards which positive ions, e.g., Li⁺, conduct, flow or move during discharge of the battery. As used herein, the phrase “negative electrode” refers to the electrode in a secondary battery from where positive ions, e.g., Li⁺, flow or move during discharge of the battery. In a battery comprised of a Li-metal electrode and a conversion chemistry, intercalation chemistry, or combination conversion/intercalation chemistry-including electrode (i.e., cathode active material; e.g., NiFx, NCA, LiNiₓMn_{y}Co_{z}O₂ [NMC] or LiNiₓAl_{y}Co_{z}O₂ [NCA], wherein x+y+z=1), the electrode having the conversion chemistry, intercalation chemistry, or combination conversion/intercalation chemistry material is referred to as the positive electrode. In some usages, cathode is used in place of positive electrode, and anode is used in place of negative electrode. When a Li-secondary battery is charged, Li ions move from the positive electrode (e.g., NiFx, NMC, NCA) towards the negative electrode (e.g., Li-metal). When a Li-secondary battery is discharged, Li ions move towards the positive electrode and from the negative electrode.

As used herein the phrase “solid separator” refers to a Li⁺ ion-conducting material that is substantially insulating to electrons (e.g., the lithium ion conductivity is at least 10³ times, and often 10⁶ times, greater than the electron conductivity), and which acts as a physical barrier or spacer between the positive and negative electrodes in an electrochemical cell.

As used herein, the term “LPSI” refers to a lithium conducting electrolyte comprising Li, P, S, and I. More generally, it is understood to include ₐLi₂S+_{b}P₂S_{y}+_{c}LiX where X═Cl, Br, and/or I and where y=3-5 and where a/b=2.5-4.5 and where (a+b)/c=0.5-15.

As used herein, “LSTPS” refers to a material characterized by the formula LiₐMP_{b}S_{c}, where M is Si, Ge, Sn, and/or Al, and where 2≤a≤8, 0.5≤b≤2.5, 4≤c≤12. “LSPS” refers to an electrolyte material characterized by the formula LₐSiP_{b}S_{c}, where 2≤a≤8, 0.5≤b≤2.5, 4≤c≤12. LSPS refers to an electrolyte material characterized by the formula LₐSiP_{b}S_{c}, wherein, where 2≤a≤8, 0.5≤b≤2.5, 4≤c≤12, d<3. Exemplary LSTPS materials are found, for example, in International Patent Application No. PCT/US14/38283, SOLID STATE CATHOLYTE OR ELECTROLYTE FOR BATTERY USING Li_{A}MP_{B}S_{C} (M=SI, GE, AND/OR SN), filed May 15, 2014, and published as WO 2014/186634, on Nov. 20, 2014,which is incorporated by reference herein in its entirety. Exemplary LSTPS materials are found, for example, in U.S. patent application Ser. No. 14/618,979, filed Feb. 10, 2015, and published as Patent Application Publication No. 2015/0171465, on Jun. 18, 2015, which is incorporated by reference herein in its entirety. When M is Sn and Si—both are present. As used herein, “LSTPSO” refers to LSTPS that is doped with, or has, O present. In one embodiment, “LSTPSO” is a LSTPS material with an oxygen content between 0.01 and 10 atomic %. “LSPS” refers to an electrolyte material having Li, Si, P, and S chemical constituents. As used herein “LSTPS” refers to an electrolyte material having Li, Si, P, Sn, and S chemical constituents. As used herein, “LSPSO” refers to LSPS that is doped with, or has, O present. In one embodiment, “LSPSO” is a LSPS material with an oxygen content between 0.01 and 10 atomic %. As used herein, “LATP,” refers to an electrolyte material having Li, As, Sn, and P chemical constituents. As used herein “LAGP” refers to an electrolyte material having Li, As, Ge, and P chemical constituents. As used herein, “LSTPSO” refers to a catholyte material characterized by the LiₐMP_{b}S_{c}O_{d}, where M is Si, Ge, Sn, and/or Al, and where 2≤a≤8, 0.5≤b≤2.5, 4≤c≤12, d<3. LSTPSO refers to LSTPS, as defined above, and having oxygen doping at from 0.1 to about 10 atomic %. LPSO refers to LPS, as defined above, and having oxygen doping at from 0.1 to about 10 atomic %.

As used herein, “LTS” refers to a lithium tin sulfide compound which can be described as Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In certain embodiments, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In. As used herein, “LATS” refers to LTS, as used above, and further comprising Arsenic (As).

As used herein the phrase “annealing,” refers heating a material, e.g., from 100° C. to 400° C., or e.g., 100° C., 150° C., 200° C., 250° C., 300° C., or 350° C. in a controlled and reducing atmosphere, e.g., dry air.

As used herein the phrase “stable at high voltage,” refers to a material (e.g., a coated cathode active material) which does not react at high voltage (4.2 V or higher versus Li metal) in a way that materially or significantly degrades the ionic conductivity or resistance of the material when held at high voltage for at least three days. Herein, a material or significant degradation in ionic conductivity or resistance is a reduction in ionic conductivity, or an increase in resistance, by an order of magnitude or more. As used herein, the term “high voltage” means at least 4.2 V versus lithium metal (i.e., v. Li). High voltage may also refer to higher voltage, e.g., 4.3, 4.4, 4.5, 4.6, 4.7, 4.8. 4.9, 5.0 V or higher.

As used herein, high voltage means 4.2 V or larger versus a lithium metal reference electrode (which is at 0 V) unless specified to the contrary.

As used herein the phrase “stable at high temperature,” refers to a material (e.g., a coated cathode active material) which does not react at high temperature (60° C. or higher) in a way that materially or significantly degrades the ionic conductivity or resistance of the material when held at high temperature for at least three days.

As used herein, area-specific resistance (ASR) is measured by electrochemical cycling using an Arbin or Biologic instrument unless otherwise specified to the contrary.

As used herein, ionic conductivity is measured by electrical impedance spectroscopy methods known in the art.

As used herein, the term “LZO” refers to Li₂ZrO₃, ZrO₂, or a combination thereof. LZO may be crystalline, amorphous, or a combination thereof. For example, LZO may include crystalline ZrO₂ and amorphous Li₂ZrO₃. For example, LZO may include ZrO₂. For example, LZO may include Li₂ZrO₃.

### DETAILED DESCRIPTION

In one embodiment, set forth herein is a composition comprising: a cathode active material; and an oxide bonded to the cathode active material, wherein: the oxide comprises a compound of the formula LiₓZr_{y}PₐO_{d}, wherein 0.05≤x≤8.0, 0≤y≤3.0, 0≤a≤6.0; and 2.0≤d≤20.0; and, wherein the formula is charge neutral. In an alternative embodiment, the oxide comprises a compound of the formula LiₓZr_{y}PₐO_{d}, wherein 0.05≤x≤8.0, 0≤y≤3.0, 0≤a≤6.0; and 2.0≤d≤20.0; wherein y and a are not both zero and wherein the formula is charge neutral. In an alternative embodiment, the oxide comprises a compound of the formula LiₓZr_{y}PₐO_{d}, wherein 0.05≤x≤25.0, 0≤y≤5.0, 0≤a≤16.0; and 2.0≤d≤55.0; wherein y and a are not both zero and wherein the formula is charge neutral. In an alternative embodiment, the oxide comprises a compound of the formula LiₓZr_{y}PₐO_{d}, wherein 20.0≤x≤25.0, 2.0≤y≤5.0, 10.0≤a≤16.0; and 50.0≤d≤55.0 and wherein the formula is charge neutral. In a further embodiment, including any of the foregoing, the composition has a ratio of Zr:Ni, as measured by x-ray photoelectron spectroscopy (XPS) of 0.3 to 3.2.

In an alternative embodiment, set forth herein is a composition comprising: a cathode active material having a surface and an oxide on the surface; wherein the oxide is selected from the group consisting of: amorphous lithium zirconium oxide, amorphous lithium zirconium phosphorus oxide, and combinations thereof; wherein the composition has a ratio of Zr:Ni, as measured by x-ray photoelectron spectroscopy (XPS) of 0.3 to 3.2.

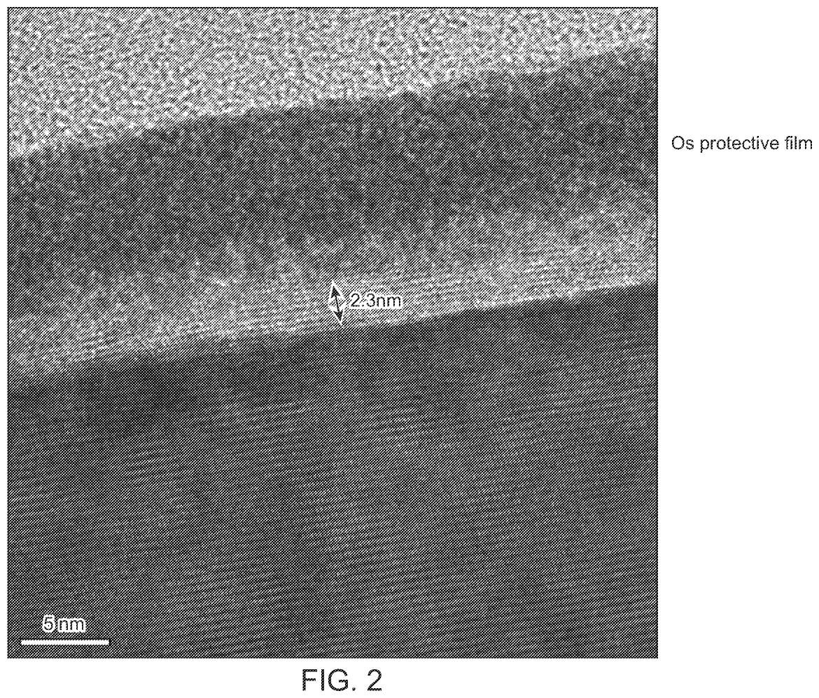

In an alternative embodiment, the composition comprises a cathode active material having a surface and an oxide on the surface; wherein the oxide is selected from the group consisting of: LiZr₂(PO₄)₃, Li₂ZrO₃, Li₃ZrPO₆, Li₅PZrO₇, Li₇ZrPO₈, Li₂₄Zr₃P₁₄O₅₃, and combinations thereof; wherein the composition has a ratio of Zr:Ni, as measured by x-ray photoelectron spectroscopy (XPS) of 0.3 to 3.2. In one embodiment, the oxide is lattice matched with the cathode active material. In one embodiment, the oxide has a surface that is crystalline. In one embodiment, the oxide has a surface that is amorphous. In one embodiment, the composition has an interface substantially as shown in any one of FIGS. 2-6. In one embodiment, the oxide is a coating that is continuous. In one embodiment, the oxide is coating that is discontinuous.

Herein oxide refers to a material bonded to the cathode active material, and not the cathode active material itself, even when the cathode active material is an oxide, unless specified otherwise explicitly to the contrary herein. For example, NMC is an oxide. However, set forth herein are other oxides which bond to the NMC oxide. These other oxides, which are different from the oxide which is the cathode active material, are described above and below.

In one embodiment, the oxide comprises a compound of the formula LiₓZr_{y}PₐO_{d}, wherein 0.05≤x≤1.5, 1.0≤y≤3.0, 1.0≤a≤6.0, and 2.0≤d≤20.0 and wherein the formula is charge neutral.

In one embodiment, the oxide comprises a compound of the formula LiₓZr_{y}PₐO_{d}, wherein 0.5≤x≤7.0, 1.0≤y≤3.0, 1.0≤a≤4.0, and 5.0≤d≤14.0 and wherein the formula is charge neutral. In one embodiment, the oxide comprises a compound of the formula LiₓZr_{y}PₐO_{d}, wherein 0.5≤x≤7.0, y is 1.0, a is 1.0, and 6.0≤d≤14.0 and wherein the formula is charge neutral.

In certain embodiments, including any of the foregoing, the oxide comprises a compound of the formula LiₓZr_{y}PₐO_{d} wherein x is selected from 1.0, 2.0, 3.0, 5.0, and 7.0. In certain embodiments, including any of the foregoing, the oxide comprises a compound of the formula LiₓZr_{y}PₐO_{d} wherein y is selected from 0, 1.0, and 2.0. In certain embodiments, including any of the foregoing, the oxide comprises a compound of the formula LiₓZr_{y}PₐO_{d} wherein a is selected from 0, 1.0, and 3.0. In certain embodiments, including any of the foregoing, the oxide comprises a compound of the formula LiₓZr_{y}PₐO_{d} wherein x is selected from 3.0, 4.0, 6.0, 7.0, 8.0, and 12.0. In an alternative embodiment, including any of the foregoing, the oxide comprises a compound of the formula LiₓZr_{y}PₐO_{d} wherein x is 24.0.

In one embodiment, the oxide comprises a compound of the formula LiₓZr_{y}PₐO_{d}, wherein 0.5≤x≤2.0, 0≤y≤3.0, 1.0≤a≤4.0, and 10.0≤d≤13.0 and wherein the formula is charge neutral. In one embodiment, the oxide comprises a compound of the formula LiₓZr_{y}PₐO_{d}, wherein 1.0≤x≤2.0, 1.0≤y≤3.0, 2.0≤a≤4.0, and 11.0≤d≤13.0 and wherein the formula is charge neutral. In one embodiment, the oxide comprises a compound of the formula LiₓZr_{y}PₐO_{d}, wherein 0.05≤x≤1.5, 1≤y≤3, 2.0≤a≤4.0; and 10.0≤d≤14.0 and wherein the formula is charge neutral.

In one embodiment, the oxide comprises a compound of the formula LiₓZr_{y}PₐO_{d}, wherein 1.0≤x≤4.0, 0≤y≤2.0, 1.0≤a≤3.0, and 4.0≤d≤7.0 and wherein the formula is charge neutral.

In one embodiment, the oxide comprises a compound of the formula LiₓZr_{y}PₐO_{d}, wherein 1.0≤x≤3.0, 0≤y≤2.0, 0≤a≤2.0, and 5.0≤d≤8.0 and wherein the formula is charge neutral.

In one embodiment, the oxide comprises a compound of the formula LiₓZr_{y}PₐO_{d}, wherein 5.0≤x≤8.0, 0≤y≤2.0, 0≤a≤2.0, and 6.0≤d≤9.0 and wherein the formula is charge neutral.

In one embodiment, the oxide comprises a compound of the formula LiₓZr_{y}PₐO_{d}, wherein 0.05≤x≤25.0, 0≤y≤5.0, 0≤a≤16.0; and 2.0≤d≤55.0 and wherein the formula is charge neutral. In one embodiment, the oxide comprises a compound of the formula LiₓZr_{y}PₐO_{d}, wherein 20.0≤x≤25.0, 2.0≤y≤5.0, 10.0≤a≤16.0; and 50.0≤d≤55.0 and wherein the formula is charge neutral.

In one embodiment, the oxide comprises a compound of the formula LiₓZr_{y}O_{d}, wherein 1.0≤x≤3, 0≤y≤2, and 2.0≤d≤5.0 and wherein the formula is charge neutral.

In one embodiment, the oxide comprises a compound of the formula LiₓPₐO_{d}, wherein 2.0≤x≤4, 0≤a≤2.0, and 2.0≤d≤5.0 and wherein the formula is charge neutral.

In some embodiments, including any of the foregoing, the oxide comprises a chemical formula selected from LiZr₂(PO₄)₃, Li₃ZrPO₆, Li₅PZrO₇, Li₇ZrPO₈, Li₃PO₄, and Li₂ZrO₃.

In an alternative embodiment, including any of the foregoing, the oxide comprises a chemical formula selected from LiZr₂(PO₄)₃, Li₃ZrPO₆, Li₅PZrO₇, Li₇ZrPO₈, Li₃PO₄, Li₂ZrO₃, and Li₂₄Zr₃P₁₄O₅₃.

In one embodiment, the oxide comprises amorphous lithium zirconium oxide, amorphous lithium zirconium phosphorus oxide, or a combination thereof.

In one embodiment, the oxide comprises LiZr₂(PO₄)₃.

In one embodiment, the oxide comprises Li₃ZrPO₆.

In one embodiment, the oxide comprises Li₅PZrO₇.

In one embodiment, the oxide comprises Li₇ZrPO₈.

In one embodiment, the oxide comprises Li₃PO₄.

In one embodiment, the oxide comprises Li₂ZrO.

In an alternative embodiment, the oxide comprises Li₂₄Zr₃P₁₄O₅₃.

When the oxides are described as comprising a compound of a formula, the ratio of Li, Zr, and P is the nominal ratio based on the ratio of the precursors used to make the oxide. The ratio of Li, Zr, and P is the ratio of the precursors as batched in the process of making the oxide, unless specified otherwise. For example, in some embodiments, the ratio is specified otherwise by stating that a composition is characterized by an atomic ratio that is determined by XPS. That XPS-determined atomic ratio is measured on the product and not as batched. In other embodiments, if a compound is characterized as the oxide Li₃PO₄, then the oxide was made, or could have been made, using precursors that had a ratio of Li:P:O of about 3:1:4 by mole as batched.

In certain embodiments, the oxide is a product of a reaction mixture of 1) LiOH and 2) a zirconium precursor and/or a phosphorus precursor. In certain embodiments, the molar ratio of Li:Zr is a ratio selected from about 1:3, about 1:2, about 1:1, about 2:1, about 3:1, about 4:1, about 5:1, about 6:1, about 7:1, about 8:1 about 9:1, and about 10:1. In one embodiment, the molar ratio of Li:Zr (i.e., LiOH:the zirconium precursor) is a ratio in the range of about 1:3 to 1:1. In one embodiment, the molar ratio of Li:Zr is a ratio in the range of about 1:1 to 3:1. In one embodiment, the molar ratio of Li:Zr is a ratio in the range of about 2:1 to 4:1. In one embodiment, the molar ratio of Li:Zr is a ratio in the range of about 1:4 to 1:6. In one embodiment, the molar ratio of Li:Zr is a ratio in the range of about 1:6 to 1:8. In certain embodiments, the molar ratio of Li:Zr is a ratio selected from about 1:2, about 2:1, about 3:1 about 1:5, about 1:7. In an alternative embodiment, the molar ratio of Li:Zr is in the range of about 24:5 to 25:2. In an alternative embodiment, the molar ratio of Li:Zr is about 24:3.

In certain embodiments, including any of the foregoing, the molar ratio of Li:P (i.e., LiOH:the phosphorus precursor) in the reaction mixture is a ratio selected from about 1:2, about 2:3, about 1:1, about 2:1, about 4:1, about 5:1, about 6:1, about 8:1, about 10:1, about 12:1, about 14:1, and 16:1. In one embodiment, including any of the foregoing, the molar ratio of Li:P is a ratio in the range of about 1:2 to 1:1. In one embodiment, including any of the foregoing, the molar ratio of Li:P is a ratio in the range of about 5:1 to 7:1. In one embodiment, including any of the foregoing, the molar ratio of Li:P is a ratio in the range of about 8:1 to 10:1. In one embodiment, including any of the foregoing, the molar ratio of Li:P is a ratio in the range of about 13:1 to 15:1. In certain embodiments, including any of the foregoing, the molar ratio of Li:P is a ratio selected from about 2:3, about 6:1, about 10:1 and about 14:1. In alternative embodiments, including any of the foregoing, the molar ratio of Li:P is a ratio between about 24:16 and 24:10. In alternative embodiments, including any of the foregoing, the molar ratio of Li:P is about 24:14.

In certain embodiments, including any of the foregoing, the molar ratio of the Zr:P in the reaction mixture is a ratio selected from about 1:2, about 1:1, about 1.3:1, about 1.5:1, about 1.8:1, about 2:1, about 3:1, and about 4:1. In one embodiment, including any of the foregoing, the molar ratio of Zr:P (i.e., zirconium precursor:the phosphorus precursor) is a ratio in the range of about 1:1 to 1.5:1. In one embodiment, including any of the foregoing, the molar ratio of Zr:P is a ratio in the range of about 1.1 to 3:1. In certain embodiments, including any of the foregoing, the molar ratio of Zr:P is a ratio selected from about 1.3:1 or about 2:1. In alternative embodiments, including any of the foregoing, the molar ratio of Zr:P is a ratio selected from about 3:20 to about 3:10. In alternative embodiments, including any of the foregoing, the molar ratio of Zr:P is a ratio of about 3:14.

In certain embodiments, including any of the foregoing, the starting molar ratio of LiOH:Zr:P is between about 20:50:30 to 25:40:35. In one embodiment, including any of the foregoing, the starting molar ratio of LiOH:Zr:P is between about 20:40:40 to 30:50:20. In one embodiment, including any of the foregoing, the starting molar ratio of LiOH:Zr:P is between about 20:40:40 to 25:45:30.

In certain embodiments, including any of the foregoing, the starting molar ratio of LiOH:Zr:P is between about 40:35:25 to 60:20:20. In one embodiment, including any of the foregoing, the starting molar ratio of LiOH:Zr:P is between about 50:25:25 to 50:35:15.

In one embodiment, including any of the foregoing, the starting molar ratio of LiOH:Zr:P is between about 80:15:5 to 65:25:10. In one embodiment, including any of the foregoing, the starting molar ratio of LiOH:Zr:P is between about 70:25:5 to 80:10:10.

In one embodiment, including any of the foregoing, the starting molar ratio of LiOH:Zr:P is between about 80:10:10 to 85:10:5. In one embodiment, including any of the foregoing, the starting molar ratio of LiOH:Zr:P is between about 80:10:10 to 82.5:12.5:5.

In certain embodiments, including any of the foregoing, the starting molar ratio of LiOH and Zr:P is between about 70:30 to 65:35. In one embodiment, including any of the foregoing, the starting molar ratio of LiOH and Zr:P is between about 60:40 to 80:20. In one embodiment, including any of the foregoing, the starting molar ratio of LiOH and Zr:P is between about 60:40 to 70:30.

In certain embodiments, including any of the foregoing, the starting molar ratio of LiOH and Zr:P is between about 75:25 to 80:20. In one embodiment, including any of the foregoing, the starting molar ratio of LiOH and Zr:P is between about 75:25 to 85:15.

In one embodiment, including any of the foregoing, the starting molar ratio of LiOH and Zr:P is between about 95:5 to 90:10. In one embodiment, including any of the foregoing, the starting molar ratio of LiOH and Zr:P is between about 95:5 to 90:10.

In one embodiment, including any of the foregoing, the starting molar ratio of LiOH and Zr:P is between about 90:10 to 95:5. In one embodiment, including any of the foregoing, the starting molar ratio of LiOH and Zr:P is between about 90:10 to 95:5.

In one embodiment, including any of the foregoing, the oxide comprises LiZr₂(PO₄)₃ and is a product of a reaction mixture of 1) LiOH; 2) a zirconium precursor; and, 3) a phosphorus precursor wherein the ratio of Li:Zr is about 1:2; the ratio of Li:P is about 2:3; and, the ratio of the Zr:P is about 1.3:1. In a further embodiment, the product is a reaction mixture of 1) LiOH; 2) Zr(OBu)₄; and, 3) P₂O₅.

In one embodiment, including any of the foregoing, the oxide comprises Li₃ZrPO₆ and is a product of a reaction mixture of 1) LiOH; 2) a zirconium precursor; and, 3) a phosphorus precursor wherein the ratio of Li:Zr is about 3:1; the ratio of Li:P is about 6:1; and, the ratio of Zr:P is about 2:1. In a further embodiment, the product is a reaction mixture of 1) LiOH; 2) Zr(OBu)₄; and, 3) P₂O₅.

In one embodiment, including any of the foregoing, the oxide comprises Li₅PZrO₇ and is a product of a reaction mixture of 1) LiOH; 2) a zirconium precursor; and, 3) a phosphorus precursor wherein the ratio of Li:Zr is about 5:1; the ratio of Li:P is about 10:1; and, the ratio of Zr:P is about 2:1. In a further embodiment, the product is a reaction mixture of 1) LiOH; 2) Zr(OBu)₄; and, 3) P₂O₅.

In one embodiment, including any of the foregoing, the oxide comprises Li₇ZrPO₈ and is a product of a reaction mixture of 1) LiOH; 2) a zirconium precursor; and, 3) a phosphorus precursor wherein the ratio of Li:Zr is about 7:1; the ratio of Li:P is about 14:1; and, the ratio of Zr:P is about 2:1. In a further embodiment, the product is a reaction mixture of 1) LiOH; 2) Zr(OBu)₄; and, 3) P₂O₅.

In one embodiment, including any of the foregoing, the oxide comprises Li₂₄Zr₃P₁₄O₅₃ and is a product of a reaction mixture of 1) LiOH; 2) a zirconium precursor; and, 3) a phosphorus precursor wherein the ratio of Li:Zr is about 24:3; the ratio of Li:P is about 24:14; and, the ratio of Zr:P is about 3:14. In a further embodiment, the product is a reaction mixture of 1) LiOH; 2) Zr(OBu)₄; and, 3) P₂O₅.

In one embodiment, the oxide is a product of a reaction mixture of 1) LiOH and 2) a zirconium precursor. In certain embodiments, the starting molar ratio of Li:Zr is about 30:70, about 40:60, about 50:50, about 60:40, about 65:35, and about 70:30. In one embodiment, the starting molar ratio of Li:Zr is about 60:40 to 70:30. In one embodiment, the starting molar ratio of Li:Zr is about 55:45 to 65:35. In one embodiment, the starting molar ratio of Li:Zr is about 65:35 to 75:25. In one embodiment, the starting molar ratio of Li:Zr is about 66:33.

In certain embodiments, the oxide is a product of a reaction mixture of 1) LiOH and 2) a phosphorus precursor. In certain embodiments, the starting molar ratio of Li:P is about 80:20 to 90:10. In certain embodiments, the starting molar ratio of Li:P is about 75:25 to 85:15. In certain embodiments, the starting molar ratio of Li:P is about 85:25 to 95:5. In certain embodiments the starting molar ratio of Li:P is about 85:15.

In one embodiment, including any of the foregoing, the phosphorus precursor is selected from P₂O₅, H₃PO₄, (NH₄)₃PO₄, (NH₃)₃PO₄, and combinations thereof. In one embodiment, including any of the foregoing, the zirconium precursor is zirconium butoxide (Zr(OBu)₄), zirconium propoxide (Zr(OPr)₄), zirconium ethoxide (Zr(OEt)₄), zirconium methoxide (Zr(OMe)₄), and combinations thereof. In one embodiment, including any of the foregoing, the lithium precursor is selected from lithium hydroxide (LiOH), lithium ethoxide (LiOEt), lithium methoxide (LiOMe), metallic lithium, and combinations thereof. In one embodiment, including any of the foregoing, the zirconium precursor and/or phosphorus precursor is a sol-gel precursor, such as a zirconium alkoxide or a phosphorus alkoxide precursor. In one embodiment, the phosphorus precursor is P₂O₅. In one embodiment, the zirconium precursor is Zr(OBu)₄. In one embodiment, the lithium precursor is LiOH.

In one embodiment, including any of the foregoing, the oxide is a coating on the cathode active material.

In one embodiment, including any of the foregoing, the oxide or coating further comprises amorphous domains based on transmission electron microscopy (TEM) analysis. In one embodiment, including any of the foregoing, the oxide or coating further comprises crystalline domains based on transmission electron microscopy (TEM) analysis. In one embodiment, including any of the foregoing, the oxide or coating further comprises amorphous domains based on transmission electron microscopy (TEM) analysis in addition to the crystalline domains based on transmission electron microscopy analysis.

In one embodiment, including any of the foregoing, the crystalline domains are in contact with the cathode active material.

In one embodiment, including any of the foregoing, the amorphous domains are not in contact with the cathode active material.

In one embodiment, including any of the foregoing, the crystalline domains are in contact with the cathode active material and the amorphous domains are in contact with the crystalline domains.

In one embodiment, including any of the foregoing, the coating is continuous. In one embodiment, the coating is discontinuous.

In certain embodiments, including any of the foregoing, the coating has a thickness, T, as determined by TEM analysis, that is 1 nm≤T≤20 nm.

In certain embodiments, including any of the foregoing, the coating has a thickness, T, as determined by TEM analysis, that is less than 1 nm.

In certain embodiments, including any of the foregoing, the coating has a thickness, T, as determined by scanning electron microscopy (SEM) analysis, that is 1 nm≤T≤20 nm.

In certain embodiments, including any of the foregoing, T is about 1 nm, about 5 nm, or about 10 nm. In one embodiment, including any of the foregoing, T is about 1 nm. In one embodiment, including any of the foregoing, T is about 2 nm. In one embodiment, including any of the foregoing, T is about 3 nm. In one embodiment, including any of the foregoing, T is about 4 nm. In one embodiment, including any of the foregoing, T is about 5 nm. In certain embodiments, including any of the foregoing, T is about 6 nm. In one embodiment, including any of the foregoing, T is about 7 nm. In one embodiment, including any of the foregoing, T is about 8 nm. In one embodiment, including any of the foregoing, Tis about 9 nm. In one embodiment, including any of the foregoing, T is about 10 nm. In another embodiment, including any of the foregoing, T is about 11 nm. In another embodiment, including any of the foregoing, T is about 12 nm.

In certain embodiments, including any of the foregoing, T is between about 0.8 nm and 10 nm. In one embodiment, including any of the foregoing, T is between about 0.8 nm and 5 nm. In one embodiment, including any of the foregoing, T is between about 0.8 nm and 2.5 nm. In one embodiment, including any of the foregoing, T is between about 0.8 nm and 1.5 nm. In one embodiment, including any of the foregoing, T is between about 1 nm and 4 nm. In one embodiment, including any of the foregoing, T is between about 1.5 nm and 3.5 nm. In other embodiments, including any of the foregoing, T is between about 5 nm and 10 nm. In one embodiment, including any of the foregoing, T is between about 7 nm and 10 nm.

In certain embodiments, including any of the foregoing, the coating is not an even layer and T can range in thicknesses from about 0.8 nm to 12 nm. In one embodiment, including any of the foregoing, T ranges in thickness from about 0.8 nm to 5 nm. In one embodiment, including any of the foregoing, T ranges in thickness from about 1 nm to 3.5 nm. In one embodiment, including any of the foregoing, T ranges in thickness from about 1.5 nm to 4 nm. In one embodiment, including any of the foregoing, T ranges in thickness from about 5 nm to 12 nm. In one embodiment, including any of the foregoing, T ranges in thickness from about 5 nm to 8 nm.

In certain embodiments, including any of the foregoing, T is less than about 12 nm. In certain embodiments, including any of the foregoing, T is less than about 11 nm. In certain embodiments, including any of the foregoing, T is less than about 10 nm. In certain embodiments, including any of the foregoing, T is less than about 9 nm. In certain embodiments, including any of the foregoing, T is less than about 8 nm. In certain embodiments, including any of the foregoing, T is less than about 7 nm. In certain embodiments, including any of the foregoing, T is less than about 6 nm. In certain embodiments, including any of the foregoing, T is less than about 5 nm. In certain embodiments, including any of the foregoing, T is less than about 4 nm. In certain embodiments, including any of the foregoing, T is less than about 3 nm. In certain embodiments, including any of the foregoing, T is less than about 2 nm. In certain embodiments, including any of the foregoing, T is less than about 1 nm.

In certain embodiments, including any of the foregoing, T is not thicker than the TEM can detect, for example as described herein.

In certain embodiments, including any of the forgoing, the coating comprises both crystalline and amorphous domains and the thickness of the crystalline domain is between about 0.8 nm and 5 nm and the thickness of the amorphous domain is between about 0.8 nm and 5 nm. In one embodiment, the thickness of the crystalline domain is between about 1 nm and 3 nm and the thickness of the amorphous domain is between about 1 nm and 4 nm. In one embodiment, the thickness of the crystalline domain is between about 1.5 nm and 2.5 nm and the thickness of the amorphous domain is between about 2 nm and 4 nm. In one embodiment, the thickness of the crystalline domain is less than the thickness of the amorphous domain. In another embodiment, the thickness of the crystalline domain is greater than the thickness of the amorphous domain. In certain embodiments, including any of the foregoing, the crystalline domain is in contact with the cathode active material and the amorphous domain is in contact with the crystalline domain.

In any of the foregoing embodiments, the thickness is ±20% of the described thickness. In any of the foregoing embodiments, the thickness is ±10% of the described thickness.

In one embodiment, including any of the foregoing, the oxide or coating crystalline domains do not lattice match the crystalline domains of the cathode active material, as determined by TEM analysis.

In one embodiment, including any of the foregoing, the oxide or coating crystalline domains do not lattice match the crystalline domains of the cathode active material, as determined by SEM analysis.

In one embodiment, including any of the foregoing, the oxide or coating crystalline domains do lattice match the crystalline domains of the cathode active material, as determined by TEM analysis.

In one embodiment, including any of the foregoing, the oxide or coating crystalline domains do lattice match the crystalline domains of the cathode active material, as determined by SEM analysis.

In one embodiment, including any of the foregoing, the coating further comprises carbonate.

In one embodiment, including any of the foregoing, the composition further comprises a second coating in contact with the first coating wherein the first coating is in contact with the active cathode material.

In one embodiment, including any of the foregoing, the second coating has a chemical formula which is not the same as the chemical formula of the coating.

In certain embodiments, including any of the foregoing, the second coating comprises a compound of the chemical formula:
LiₓB_{y}O_{z}, wherein 0.2≤x≤0.75, 0.5≤y≤1.6, and 1.5≤z≤2.6;
LiₓC_{y}O_{z}, wherein 0.4≤x≤1.8, 0.1≤y≤1, and 1≤z≤1.8;
LiₓZr_{y}O_{z}, wherein 0≤x≤1.6, 0.2≤y≤1.0, and 2≤z≤1.2;
LiₓP_{y}O_{z}, wherein 0.6≤x≤1.5, 0.5≤y≤1.4, and 2.0≤z≤3.7;
LiₓZr_{y}(PO₄)_{z}, wherein 0.05≤x≤1.5, 1≤y≤3, and 2.0≤z≤4.0;
LiₓNb_{y}O_{z}, wherein 0.5≤x≤1.5, 0.5≤y≤1.5, and 2≤z≤4;
LiₓTi_{y}O_{z}, wherein 0≤x≤1.6, 0.2≤y≤1.0, and 2≤z≤1.2;
LiₓTi_{y}P_{w}O_{z}, wherein 0≤x≤2, 1≤y≤3, 1≤w≤4, and 2≤z≤20;
LiₓZr_{y}P_{w}O_{z}, wherein 0≤x≤2, 1≤y≤3, 1≤w≤4, and 2≤z≤20;
LiₓZr_{y}F_{z}, wherein 0.2≤x≤0.75, 0.25≤y≤0.8, and 1.75≤z≤3.4;
LiₓTi_{y}F_{z}, wherein 0.2≤x≤0.75, 0.25≤y≤0.8, and 1.75≤z≤3.4;
LiₓAl_{y}F_{z}, wherein 0.4≤x≤0.8, 0.2≤y≤0.6, and 1.4≤z≤2.2;
LiₓY_{y}F_{z}, wherein 0.4≤x≤0.8, 0.2≤y≤0.6, and 1.4≤z≤2.2;
LiₓNb_{y}F_{z}, wherein 0.2≤x≤0.8, 0.2≤y≤0.8, and 1.8≤z≤4.2; or
a combination thereof. Subscripts x, y, and z, are selected so the compound is charge neutral.

In certain embodiments, including any of the foregoing, the second coating comprises a compound of the formula: Li₂CO₃; Li₃BO₃; Li₃B₁₁O₁₈; Li₂ZrO₃; Li₃PO₄; Li₂SO₄; LiNbO₃; Li₄Ti₅O₁₂; LiTi₂(PO₄)₃; LiZr₂(PO₄)₃; LiOH; LiF; Li₄ZrF₈; Li₃Zr₄F₁₉; Li₃TiF₆; LiAlF₄; LiYF₄; LiNbF₆; ZrO₂; Al₂O₃; TiO₂; ZrF₄; AlF₃; TiF₄; YF₃; NbF₅; or a combination thereof

In one embodiment, the second coating comprises Li₂CO₃. In one embodiment, the second coating comprises Li₃BO₃. In one embodiment, the second coating comprises Li₃B₁₁O₁₈. In one embodiment, the second coating comprises Li₂ZrO₃. In one embodiment, the second coating comprises Li₃PO₄. In one embodiment, the second coating comprises Li₂SO₄. In one embodiment, the second coating comprises LiNbO₃. In one embodiment, the second coating comprises Li₄Ti₅O₁₂. In one embodiment, the second coating comprises LiTi₂(PO₄)₃. In one embodiment, the second coating comprises LiZr₂(PO₄)₃. In one embodiment, the second coating comprises LiOH. In one embodiment, the second coating comprises LiF. In one embodiment, the second coating comprises Li₄ZrF₈. In one embodiment, the second coating comprises Li₃Zr₄F₁₉. In one embodiment, the second coating comprises Li₃TiF₆. In one embodiment, the second coating comprises LiAlF₄. In one embodiment, the second coating comprises LiYF₄. In one embodiment, the second coating comprises LiNbF₆. In one embodiment, the second coating comprises ZrO₂. In one embodiment, the second coating comprises Al₂O₃. In one embodiment, the second coating comprises TiO₂. In one embodiment, the second coating comprises ZrF₄. In one embodiment, the second coating comprises AlF₃. In one embodiment, the second coating comprises TiF₄. In certain examples, the second coating comprises YF₃. In one embodiment, the second coating comprises NbF₅.

In one embodiment, including any of the foregoing, the second coating is amorphous as determined by TEM analysis.

In one embodiment, including any of the foregoing, the second coating is crystalline as determined by TEM analysis.

In one embodiment, including any of the foregoing, the second coating has a chemical formula which is not the same as the chemical formula of the coating.

In one embodiment, including any of the foregoing, the second coating comprises Li₃BO₃.

In one embodiment, including any of the foregoing, the second coating comprises LiₓB_{y}O_{z}, wherein 0.2≤x≤0.75, 0.5≤y≤1.6, and 1.5≤z≤2.6.

In one embodiment, including any of the foregoing, the coating comprises Li₂CO₃, Li₃BO₃, Li₃B₁₁O₁₈, LiₓB_{y}O_{z}, or a combination thereof. In the formula, LiₓB_{y}O_{z}, 0.2≤x≤0.75, 0.5≤y≤1.6, and 1.5≤z≤2.6.

In one embodiment, including any of the foregoing the second coating comprises LiₓZr_{y}O_{z}, wherein 0≤x≤1.6, 0.2≤y≤1.0, and 2≤z≤1.2.

In one embodiment, including any of the foregoing, the second coating comprises LiₓP_{y}O_{z}, wherein 0.6≤x≤1.5, 0.5≤y≤1.4, and 2.0≤z≤3.7.

In one embodiment, including any of the foregoing, the second coating comprises Li₃InCl₆.

In one embodiment, the first coating comprises a compound of the formula LiₓZr_{y}PₐO_{d}, wherein 0.05≤x≤1.5, 1.0≤y≤3.0, 1.0≤a≤6.0, and 2.0≤d≤20.0 and wherein the formula is charge neutral.

In one embodiment, the first coating comprises a compound of the formula LiₓZr_{y}PₐO_{d}, wherein 0.5≤x≤7.0, 1.0≤y≤3.0, 1.0≤a≤4.0, and 5.0≤d≤14.0 and wherein the formula is charge neutral.

In one embodiment, the first coating comprises a compound of the formula LiₓZr_{y}PₐO_{d}, wherein 0.5≤x≤2.0, 0≤y≤3.0, 1.0≤a≤4.0, and 10.0≤d≤13.0 and wherein the formula is charge neutral.

In one embodiment, the first coating comprises a compound of the formula LiₓZr_{y}PₐO_{d}, wherein 1.0≤x≤4.0, 0≤y≤2.0, 1.0≤a≤3.0, and 4.0≤d≤7.0 and wherein the formula is charge neutral.

In one embodiment, the first coating comprises a compound of the formula LiₓZr_{y}PₐO_{d}, wherein 1.0≤x≤3.0, 0≤y≤2.0, 0≤a≤2.0, and 5.0≤d≤8.0 and wherein the formula is charge neutral.

In one embodiment, the first coating comprises a compound of the formula LiₓZr_{y}PₐO_{d}, wherein 5.0≤x≤8.0, 0≤y≤2.0, 0≤a≤2.0, and 6.0≤d≤9.0 and wherein the formula is charge neutral.

In one embodiment, the first coating comprises a compound of the formula LiₓZr_{y}O_{d}, wherein 1.0≤x≤3, 0≤y≤2, and 2.0≤d≤5.0 and wherein the formula is charge neutral.

In one embodiment, the first coating comprises a compound of the formula LiₓPₐO_{d}, wherein 2.0≤x≤4, 0≤a≤2.0, and 2.0≤d≤5.0 and wherein the formula is charge neutral.

In certain embodiments, including any of the foregoing, the first coating comprises a chemical formula selected from LiZr₂(PO₄)₃, Li₃ZrPO₆, Li₅PZrO₇, Li₇ZrPO₈, Li₃PO₄, Li₂ZrO₃, and Li₂₄Zr₃P₁₄O₅₃.

In one embodiment, the first coating comprises LiZr₂(PO₄)₃.

In certain embodiments, the first coating comprises LiZr₂(PO₄)₃ and the second coating comprises a chemical formula selected from Li₃ZrPO₆, Li₅PZrO₇, Li₇ZrPO₈, Li₃PO₄, Li₂ZrO₃, and Li₂₄Zr₃P₁₄O₅₃.

In one embodiment, the first coating comprises LiZr₂(PO₄)₃ and the second coating comprises a chemical formula of the formula LiₓZr_{y}PₐO_{d}, wherein 0.05≤x≤8.0, 0≤y≤3.0, 0≤a≤6.0; and 2.0≤d≤20.0 and wherein the formula is charge neutral and second coating is not LiZr₂(PO₄)₃.

In one embodiment, the first coating comprises crystalline domains as measured by TEM and the second coating comprises crystalline or amorphous domains as measured by TEM.

In one embodiment, the first coating comprises amorphous domains as measured by TEM and the second coating comprises crystalline or amorphous domains as measured by TEM.

In one embodiment, the first coating comprises crystalline and amorphous domains as measured by TEM and the second coating comprises crystalline or amorphous domains as measured by TEM.

Also set forth herein is a coated cathode active material, comprising: a cathode active material; wherein: the cathode active material comprises a first coating and a second coating; the first coating comprises LiZr₂(PO₄)₃; the second coating comprises Li₃BO₃, Li₃B₁₁O₁₈, LiₓB_{y}O_{z}, wherein 0.2≤x≤0.75, 0.5≤y≤1.6, and 1.5≤z≤2.6, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises LiₓB_{y}O_{z}, wherein 0.2≤x≤0.75, 0.5≤y≤1.6, and 1.5≤z≤2.6, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃ the second coating comprises Li₃BO₃, Li₃B₁₁O₁₈, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises Li₃BO₃, Li₃B₁₁O₁₈, Li₂ZrO₃, Li₃PO₄, Li₂SO₄, LiₓB_{y}O_{z}, wherein 0.2≤x≤0.75, 0.5≤y≤1.6, and 1.5≤z≤2.6, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises Li₃BO₃, Li₃B₁₁O₁₈, LZO, Li₃PO₄, Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises Li₂CO₃, Li₃BO₃, Li₃B₁₁O₁₈, Li₃PO₄, Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises Li₃BO₃; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises Li₃PO₄; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiZr₂(PO₄)₃; the second coating comprises Li₂SO₄; and wherein: the first coating contacts the cathode active material; and the second coating contacts the first coating.

In certain embodiments, including any of the foregoing, the thickness of each coating is about 1 nm to 50 nm. This means that in those examples where a cathode active material has two coatings, each of the two coatings may have a thickness from 1 nm to 50 nm. Each coating may have the same or different thickness as the other coating. In one embodiment, one of the two coatings has a thickness of about 1 nm. In one embodiment, one of the two coatings has a thickness of about 2 nm. In one embodiment, one of the two coatings has a thickness of about 3 nm. In one embodiment, one of the two coatings has a thickness of about 4 nm. In one embodiment, one of the two coatings has a thickness of about 5 nm. In one embodiment, one of the two coatings has a thickness of about 6 nm. In one embodiment, one of the two coatings has a thickness of about 7 nm. In one embodiment, one of the two coatings has a thickness of about 8 nm. In one embodiment, one of the two coatings has a thickness of about 9 nm. In one embodiment, one of the two coatings has a thickness of about 10 nm. In one embodiment, one of the two coatings has a thickness of about 11 nm. In one embodiment, one of the two coatings has a thickness of about 12 nm. In one embodiment, one of the two coatings has a thickness of about 13 nm. In one embodiment, one of the two coatings has a thickness of about 14 nm. In one embodiment, one of the two coatings has a thickness of about 15 nm. In one embodiment, one of the two coatings has a thickness of about 16 nm. In one embodiment, one of the two coatings has a thickness of about 17 nm. In one embodiment, one of the two coatings has a thickness of about 18 nm. In one embodiment, one of the two coatings has a thickness of about 19 nm. In one embodiment, one of the two coatings has a thickness of about 20 nm. In one embodiment, one of the two coatings has a thickness of about 21 nm. In one embodiment, one of the two coatings has a thickness of about 22 nm. In one embodiment, one of the two coatings has a thickness of 2about 3 nm. In one embodiment, one of the two coatings has a thickness of about 24 nm. In one embodiment, one of the two coatings has a thickness of about 25 nm. In one embodiment, one of the two coatings has a thickness of about 26 nm. In one embodiment, one of the two coatings has a thickness of about 27 nm. In one embodiment, one of the two coatings has a thickness of about 28 nm. In one embodiment, one of the two coatings has a thickness of about 29 nm. In one embodiment, one of the two coatings has a thickness of about 30 nm. In one embodiment, one of the two coatings has a thickness of about 31 nm. In one embodiment, one of the two coatings has a thickness of about 32 nm. In one embodiment, one of the two coatings has a thickness of about 33 nm. In one embodiment, one of the two coatings has a thickness of about 34 nm. In one embodiment, one of the two coatings has a thickness of about 35 nm. In one embodiment, one of the two coatings has a thickness of about 36 nm. In one embodiment, one of the two coatings has a thickness of about 37 nm. In one embodiment, one of the two coatings has a thickness of about 38 nm. In one embodiment, one of the two coatings has a thickness of about 39 nm. In one embodiment, one of the two coatings has a thickness of about 40 nm. In one embodiment, one of the two coatings has a thickness of about 41 nm. In one embodiment, one of the two coatings has a thickness of about 42 nm. In one embodiment, one of the two coatings has a thickness of about 43 nm. In one embodiment, one of the two coatings has a thickness of about 44 nm. In one embodiment, one of the two coatings has a thickness of about 45 nm. In one embodiment, one of the two coatings has a thickness of about 46 nm. In one embodiment, one of the two coatings has a thickness of about 47 nm. In one embodiment, one of the two coatings has a thickness of about 48 nm. In one embodiment, one of the two coatings has a thickness of about 49 nm. In one embodiment, one of the two coatings has a thickness of about 50 nm. In one embodiment, the second of the two coatings has a thickness of about 1 nm. In one embodiment, the second of the two coatings has a thickness of about 2 nm. In one embodiment, the second of the two coatings has a thickness of about 3 nm. In one embodiment, the second of the two coatings has a thickness of about 4 nm. In one embodiment, the second of the two coatings has a thickness of about 5 nm. In one embodiment, the second of the two coatings has a thickness of about 6 nm. In one embodiment, the second of the two coatings has a thickness of about 7 nm. In one embodiment, the second of the two coatings has a thickness of about 8 nm. In one embodiment, the second of the two coatings has a thickness of about 9 nm. In one embodiment, the second of the two coatings has a thickness of about 10 nm. In one embodiment, the second of the two coatings has a thickness of about 11 nm. In one embodiment, the second of the two coatings has a thickness of about 12 nm. In one embodiment, the second of the two coatings has a thickness of about 13 nm. In one embodiment, the second of the two coatings has a thickness of about 14 nm. In one embodiment, the second of the two coatings has a thickness of about 15 nm. In one embodiment, the second of the two coatings has a thickness of about 16 nm. In one embodiment, the second of the two coatings has a thickness of about 17 nm. In one embodiment, the second of the two coatings has a thickness of about 18 nm. In one embodiment, the second of the two coatings has a thickness of about 19 nm. In one embodiment, the second of the two coatings has a thickness of about 20 nm. In one embodiment, the second of the two coatings has a thickness of about 21 nm. In one embodiment, the second of the two coatings has a thickness of about 22 nm. In one embodiment, the second of the two coatings has a thickness of about 23 nm. In one embodiment, the second of the two coatings has a thickness of about 24 nm. In one embodiment, the second of the two coatings has a thickness of about 25 nm. In one embodiment, the second of the two coatings has a thickness of about 26 nm. In one embodiment, the second of the two coatings has a thickness of about 27 nm. In one embodiment, the second of the two coatings has a thickness of about 28 nm. In one embodiment, the second of the two coatings has a thickness of about 29 nm. In one embodiment, the second of the two coatings has a thickness of about 30 nm. In one embodiment, the second of the two coatings has a thickness of about 31 nm. In one embodiment, the second of the two coatings has a thickness of about 32 nm. In one embodiment, the second of the two coatings has a thickness of about 33 nm. In one embodiment, the second of the two coatings has a thickness of about 34 nm. In one embodiment, the second of the two coatings has a thickness of about 35 nm. In one embodiment, the second of the two coatings has a thickness of about 36 nm. In one embodiment, the second of the two coatings has a thickness of about 37 nm. In one embodiment, the second of the two coatings has a thickness of about 38 nm. In one embodiment, the second of the two coatings has a thickness of about 39 nm. In one embodiment, the second of the two coatings has a thickness of about 40 nm. In one embodiment, the second of the two coatings has a thickness of about 41 nm. In one embodiment, the second of the two coatings has a thickness of about 42 nm. In one embodiment, the second of the two coatings has a thickness of about 43 nm. In one embodiment, the second of the two coatings has a thickness of about 44 nm. In one embodiment, the second of the two coatings has a thickness of about 45 nm. In one embodiment, the second of the two coatings has a thickness of about 46 nm. In one embodiment, the second of the two coatings has a thickness of about 47 nm. In one embodiment, the second of the two coatings has a thickness of about 48 nm. In one embodiment, the second of the two coatings has a thickness of about 49 nm. In one embodiment, the second of the two coatings has a thickness of about 50 nm.

In certain embodiments, including any of the foregoing, the cathode active material is selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In certain embodiments, including any of the foregoing, the cathode active material is selected from lithium cobalt oxide (LCO), lithium nickel cobalt aluminum oxide (NCA), lithium nickel manganese cobalt oxide (NMC), lithium iron phosphate (LFP), and combinations thereof.

In certain embodiments, including any of the foregoing, the cathode active material is a member of the NMC class of cathode active materials, for example, LiNiCoMnO₂. In certain embodiments, including any of the foregoing, the cathode active material is a member of the LFP class of cathode active materials, for example, LiFePO₄/C. In certain embodiments, including any of the foregoing, the cathode active material is a member of the LNMO class of cathode active materials, for example, LiNi_{0.5}Mn_{1.5}O₄ or LiNi_{0.5}Mn_{1.5}O₂. In certain embodiments, including any of the foregoing, the cathode active material is a member of the NCA class of cathode active materials, for example, LiMn₂O₄. In certain embodiments, including any of the foregoing, the cathode active material is a member of the LMO class of cathode active materials, for example, LiMn₂O₄. In certain embodiments, including any of the foregoing, the cathode active material is a member of the LCO class of cathode active materials, for example, LiCoO₂. In one embodiment, the cathode active material is LiNiO₂. In one embodiment, the cathode active material is LiNi₁₋ₓCoₓO₂ (0.2<x<0.5). The cathode active material can be any useful known cathode that is similar to the cathode active materials described herein, even if the molar ratio of the composition changes. For example, the cathode active material can be any cathode active material described in Minnmann et al. Advanced Energy Materials, 2022, 12, 2201425.

In certain embodiments, including any of the foregoing, the cathode active material is selected from LiMPO₄ (M═Fe, Ni, Co, Mn), LiₓTi_{y}O_{z}, wherein x is from 0 to 8, y is from 1 to 12, z is from 1 to 24, LiMn₂O₄, LiMn₂ₐNiₐO₄, wherein a is from 0 to 2, LiCoO₂, Li(NiCoMn)O₂, Li(NiCoAl)O₂, and a nickel cobalt aluminum oxide.

In certain embodiments, including any of the foregoing, the cathode active material is selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and, LiNiₓCo_{y}Al_{z}O₂, wherein x+y+z=1, and 0≤x≤1, 0≤y≤1, and 0≤z≤1.

In certain embodiments, including any of the foregoing, the cathode active material is LiNiₓMn_{y}Co_{z}O₂, x+y+z=1, 0≤x≤1, 0≤y≤1, and 0≤z≤1. In one embodiment, the cathode active material is LiNiₓMn_{y}Co_{z}O₂, x is 0.8, y is 0.1, and z is 0.1. In certain other examples, the coated cathode active material is LiNiₓMn_{y}Co_{z}O₂, x is 0.6, y is 0.2, and z is 0.2. In one embodiment, the coated cathode active material is LiNiₓMn_{y}Co_{z}O₂, x is 0.5, y is 0.3, and z is 0.2. In some other examples, the coated cathode active material is LiNiₓMn_{y}Co_{z}O₂, x is ⅓, y is ⅓, and z is ⅓. In certain embodiments, the coated cathode active material is selected from LiMn₂O₄, LiCoO₂, Li(NiCoMn)O₂, and Li(NiCoAl)O₂.

In one embodiment, including any of the foregoing, the cathode active material is LiNiₓMn_{y}CO_{z}O₂, x+y+z=1, 0≤x≤1, 0≤y≤1, and 0≤z≤1. In certain examples, the amount of lithium in the cathode active material will vary depending on the state-of-charge of the battery. For example, the amount of lithium may range from Li_{0.95-1.1}(NiₓMn_{y}Co_{z})O₂, wherein x, y, and z, are as defined above. In certain other examples, the amount of lithium may range from Li_{0.2-1.1}(NiₓMn_{y}Co_{z})O₂, wherein x, y, and z, are as defined above. Other ranges of lithium are contemplated herein.

In certain embodiments, including any of the foregoing, the cathode active material is LiNiₓMn_{y}Co_{z}O₂, x+y+z=1, 0.8≤x≤0.97, 0≤y≤0.2, and 0≤z≤0.2. In certain embodiments, including any of the foregoing, the cathode active material is LiNiₓMn_{y}Co_{z}O₂, x+y+z=1, 0.8≤x≤0.95, 0≤y≤0.2, and 0≤z≤0.2. In certain embodiments, including any of the foregoing, the cathode active material is LiNiₓMn_{y}Co_{z}O₂, x+y+z=1, 0.8≤x≤0.9, 0≤y≤0.2, and 0≤z≤0.2. In certain embodiments, including any of the foregoing, the cathode active material is LiNiₓMn_{y}Co_{z}O₂, x+y+z=1, 0.8≤x≤0.85, 0≤y≤0.2, and 0≤z≤0.2. In certain embodiments, including any of the foregoing, the cathode active material is LiNiₓMn_{y}Co_{z}O₂, x+y+z=1, 0.8≤x≤0.83, 0≤y≤0.2, and 0≤z≤0.2. In one embodiment, the cathode active material has high nickel content, for example, LiNiₓMn_{y}Co_{z}O₂, x+y+z=1, 0.8≤x≤0.97, 0≤y≤0.2, and 0≤z≤0.2.

As set forth herein, is a composition comprising: a cathode active material; and an oxide bonded to the cathode active material, wherein: the oxide comprises amorphous lithium zirconium oxide, amorphous lithium zirconium phosphorus oxide, or a combination thereof; and wherein the cathode active material is selected from lithium cobalt oxide (LCO), lithium nickel cobalt aluminum oxide (NCA), lithium nickel manganese cobalt oxide (NMC), lithium iron phosphate (LFP), and combinations thereof.

As set forth herein, is a composition comprising: a cathode active material; and an oxide bonded to the cathode active material, wherein: the oxide is selected from the group consisting of LiZr₂(PO₄)₃, Li₂ZrO₃, Li₃ZrPO₆, Li₅PZrO₇, Li₇ZrPO₈, Li₂₄Zr₃P₁₄O₅₃, and combinations thereof; and wherein the cathode active material is selected from lithium cobalt oxide (LCO), lithium nickel cobalt aluminum oxide (NCA), lithium nickel manganese cobalt oxide (NMC), lithium iron phosphate (LFP), and combinations thereof.

As set forth herein, is a composition comprising: a cathode active material; and an oxide bonded to the cathode active material, wherein: the oxide comprises a compound of the formula LiₓZr_{y}PₐO_{d}, wherein 0.05≤x≤8.0, 0≤y≤3.0, 0≤a≤6.0; and 2.0≤d≤20.0; and, wherein the formula is charge neutral; and wherein the cathode active material is selected from lithium cobalt oxide (LCO), lithium nickel cobalt aluminum oxide (NCA), lithium nickel manganese cobalt oxide (NMC), lithium iron phosphate (LFP), and combinations thereof. In one embodiment, the cathode active material is lithium nickel manganese cobalt oxide (NMC).

As set forth herein, is a composition comprising: a cathode active material; and an oxide bonded to the cathode active material, wherein: the oxide comprises a compound of the formula LiₓZr_{y}PₐO_{d}, wherein 0.05≤x≤25.0, 0≤y≤5.0, 0≤a≤16.0; and 2.0≤d≤55.0; and, wherein the formula is charge neutral; and wherein the cathode active material is selected from lithium cobalt oxide (LCO), lithium nickel cobalt aluminum oxide (NCA), lithium nickel manganese cobalt oxide (NMC), lithium iron phosphate (LFP), and combinations thereof. In one embodiment, the cathode active material is lithium nickel manganese cobalt oxide (NMC).

As set forth herein, is a composition comprising: a cathode active material; and an oxide bonded to the cathode active material, wherein: the oxide comprises a compound of the formula LiₓZr_{y}PₐO_{d}, wherein 0.5≤x≤7.0, 1.0≤y≤3.0, 1.0≤a≤4.0, and 5.0≤d≤14.0; and, wherein the formula is charge neutral; and wherein the cathode active material is selected from lithium cobalt oxide (LCO), lithium nickel cobalt aluminum oxide (NCA), lithium nickel manganese cobalt oxide (NMC), lithium iron phosphate (LFP), and combinations thereof. In one embodiment, the cathode active material is lithium nickel manganese cobalt oxide (NMC).

As set forth herein, is a composition comprising: a cathode active material; and an oxide bonded to the cathode active material, wherein: the oxide comprises a compound of the formula LiₓZr_{y}PₐO_{d}, wherein 0.5≤x≤2.0, 0≤y≤3.0, 1.0≤a≤4.0, and 10.0≤d≤13.0; and, wherein the formula is charge neutral; and wherein the cathode active material is selected from lithium cobalt oxide (LCO), lithium nickel cobalt aluminum oxide (NCA), lithium nickel manganese cobalt oxide (NMC), lithium iron phosphate (LFP), and combinations thereof. In one embodiment, the cathode active material is lithium nickel manganese cobalt oxide (NMC).

As set forth herein, is a composition comprising: a cathode active material; and an oxide bonded to the cathode active material, wherein: the oxide comprises a compound of the formula LiₓZr_{y}PₐO_{d}, wherein 20.0≤x≤25.0, 2.0≤y≤5.0, 10.0≤a≤16.0; and 50.0≤d≤55.0; and, wherein the formula is charge neutral; and wherein the cathode active material is selected from lithium cobalt oxide (LCO), lithium nickel cobalt aluminum oxide (NCA), lithium nickel manganese cobalt oxide (NMC), lithium iron phosphate (LFP), and combinations thereof. In one embodiment, the cathode active material is lithium nickel manganese cobalt oxide (NMC).

As set forth herein, is a composition comprising: a cathode active material; and an oxide bonded to the cathode active material, wherein: the oxide comprises a compound selected from LiZr₂(PO₄)₃, Li₃ZrPO₆, Li₅PZrO₇, Li₇ZrPO₈, Li₃PO₄, Li₂ZrO₃, and Li₂₄Zr₃P₁₄O₅₃; and wherein the cathode active material is selected from lithium cobalt oxide (LCO), lithium nickel cobalt aluminum oxide (NCA), lithium nickel manganese cobalt oxide (NMC), lithium iron phosphate (LFP), and combinations thereof. In one embodiment, the cathode active material is lithium nickel manganese cobalt oxide (NMC).

As set forth herein, is a composition comprising: a cathode active material; and an oxide bonded to the cathode active material, wherein: the oxide comprises LiZr₂(PO₄)₃; and wherein the cathode active material selected from lithium cobalt oxide (LCO), lithium nickel cobalt aluminum oxide (NCA), lithium nickel manganese cobalt oxide (NMC), lithium iron phosphate (LFP), and combinations thereof. In one embodiment, the cathode active material is lithium nickel manganese cobalt oxide (NMC).

In one embodiment, including any of the foregoing, the cathode active material is LiNiₓMn_{y}Co_{z}O₂, x+y+z=1, 0≤x≤1, 0≤y≤1, and 0≤z≤1.

In one embodiment, including any of the foregoing, the cathode active material is LiNiₓMn_{y}Co_{z}O₂, x is 0.8, y is 0.1, and z is 0.1.

In one embodiment, including any of the foregoing, the cathode active material is LiNiₓMn_{y}Co_{z}O₂, x is 0.6, y is 0.2, and z is 0.2.

In one embodiment, including any of the foregoing, the cathode active material is LiNiₓMn_{y}Co_{z}O₂, x is 0.5, y is 0.3, and z is 0.2.

In one embodiment, including any of the foregoing, the cathode active material is LiNiₓMn_{y}Co_{z}O₂, x is ⅓, y is ⅓, and z is ⅓.

In one embodiment, including any of the foregoing, the cathode active material is LiNiₓMn_{y}Co_{z}O₂, x+y+z=1, 0.8≤x≤0.97, 0≤y≤0.2, and 0≤z≤0.2. In one embodiment, including any of the foregoing, the cathode active material is LiNiₓMn_{y}Co_{z}O₂, x+y+z=1, 0.8≤x≤0.95, 0≤y≤0.2, and 0≤z≤0.2. In one embodiment, including any of the foregoing, the cathode active material is LiNiₓMn_{y}Co_{z}O₂, x+y+z=1, 0.8≤x≤0.9, 0≤y≤0.2, and 0≤z≤0.2. In one embodiment, including any of the foregoing, the cathode active material is LiNiₓMn_{y}Co_{z}O₂, x+y+z=1, 0.8≤x≤0.85, 0≤y≤0.2, and 0≤z≤0.2. In one embodiment, including any of the foregoing, the cathode active material is LiNiₓMn_{y}Co_{z}O₂, x+y+z=1, 0.8≤x≤0.83, 0≤y≤0.2, and 0≤z≤0.2.

In one embodiment, including any of the foregoing, the cathode active material is selected from LiMn₂O₄, LiCoO₂, Li(NiCoMn)O₂, and Li(NiCoAl)O₂.

Unless explicitly stated otherwise, the variables herein are chosen so that the chemical formula is charge neutral.

In certain embodiments, set forth herein is a solid-state cathode comprising a coated cathode active material set forth herein.

In one embodiment, the composition comprising the cathode active material and the oxide bonded to the cathode active material as set forth herein comprises between about 1.0 weight % and 20 weight % of lithium as measured by inductively coupled plasma (ICP) analysis. In one embodiment, the composition comprising the cathode active material and the oxide bonded to the cathode active material as set forth herein comprises between about 5.0 weight % and 10 weight % of lithium as measured by ICP analysis. In one embodiment, the composition comprising the cathode active material and the oxide bonded to the cathode active material as set forth herein comprises between about 7.0 weight % and 8 weight % of lithium as measured by ICP analysis. In one embodiment, the composition comprising the cathode active material and the oxide bonded to the cathode active material as set forth herein comprises at least 5 weight % of lithium as measured by ICP analysis. In one embodiment, the composition comprising the cathode active material and the oxide bonded to the cathode active material as set forth herein comprises less than 10 weight % of lithium as measured by ICP analysis. In one embodiment, the composition comprising the cathode active material and the oxide bonded to the cathode active material as set forth herein comprises about 7.0 weight % of lithium as measured by ICP analysis. In one embodiment, the composition comprising the cathode active material and the oxide bonded to the cathode active material as set forth herein comprises about 7.5 weight % of lithium as measured by ICP analysis.

In one embodiment, the composition comprising the cathode active material and the oxide bonded to the cathode active material as set forth herein is characterized by a ratio of lithium: manganese, cobalt, and nickel (Li/(Mn+Co+Ni) of between about 0.05-0.5 by weight percent as measured by ICP analysis. In one embodiment, the composition comprising the cathode active material and the oxide bonded to the cathode active material as set forth herein is characterized by a ratio of lithium: manganese, cobalt, and nickel (Li/(Mn+Co+Ni) of between about 0.1-0.3 by weight percent as measured by ICP analysis. In one embodiment, the composition comprising the cathode active material and the oxide bonded to the cathode active material as set forth herein is characterized by a ratio of lithium: manganese, cobalt, and nickel (Li/(Mn+Co+Ni) of less than about 0.5 by weight percent as measured by ICP analysis. In one embodiment, the composition comprising the cathode active material and the oxide bonded to the cathode active material as set forth herein is characterized by a ratio of lithium: manganese, cobalt, and nickel (Li/(Mn+Co+Ni) of at least about 0.1 by weight percent as measured by ICP analysis. In one embodiment, the composition comprising the cathode active material and the oxide bonded to the cathode active material as set forth herein is characterized by a ratio of lithium: manganese, cobalt, and nickel (Li/(Mn+Co+Ni) of about 0.12 or 0.13 by weight percent as measured by ICP analysis.

In one embodiment, the composition comprising the cathode active material and the oxide bonded to the cathode active material as set forth herein comprises between about 0.1 weight % and 1 weight % of zirconium as measured by ICP analysis. In one embodiment, the composition comprising the cathode active material and the oxide bonded to the cathode active material as set forth herein comprises between about 0.1 weight % and 0.7 weight % of zirconium as measured by ICP analysis. In one embodiment, the composition comprising the cathode active material and the oxide bonded to the cathode active material comprises as set forth herein comprises at least 0.1 weight % of zirconium as measured by ICP analysis. In one embodiment, the composition comprising the cathode active material and the oxide bonded to the cathode active material as set forth herein comprises less than 1 weight % of zirconium as measured by ICP analysis. In one embodiment, the composition comprising the cathode active material and the oxide bonded to the cathode active material as set forth herein comprises about 0.2 weight % of zirconium as measured by ICP analysis. In one embodiment, the composition comprising the cathode active material and the oxide bonded to the cathode active material comprises as set forth herein about 0.3 weight % of zirconium as measured by ICP analysis. In one embodiment, the composition comprising the cathode active material and the oxide bonded to the cathode active material as set forth herein comprises about 0.5 weight % of zirconium as measured by ICP analysis.

In one embodiment, the composition comprising the cathode active material and the oxide bonded to the cathode active material as set forth herein is characterized by a ratio of zirconium: manganese, cobalt, and nickel (Zr/(Mn+Co+Ni) of between about 0.001 and 0.01 by weight percent as measured by ICP analysis. In one embodiment, the composition comprising the cathode active material and the oxide bonded to the cathode active material as set forth herein is characterized by a ratio of zirconium: manganese, cobalt, and nickel (Zr/(Mn+Co+Ni) of between about 0.003-0.009 by weight percent as measured by ICP analysis. In one embodiment, the composition comprising the cathode active material and the oxide bonded to the cathode active material as set forth herein is characterized by a ratio of zirconium: manganese, cobalt, and nickel (Zr/(Mn+Co+Ni) of at least about 0.001 by weight percent as measured by ICP analysis. In one embodiment, the composition comprising the cathode active material and the oxide bonded to the cathode active material as set forth herein is characterized by a ratio of zirconium: manganese, cobalt, and nickel (Zr/(Mn+Co+Ni) of at least about 0.003 by weight percent as measured by ICP analysis. In one embodiment, the composition comprising the cathode active material and the oxide bonded to the cathode active material as set forth herein is characterized by a ratio of zirconium: manganese, cobalt, and nickel (Zr/(Mn+Co+Ni) less than about 0.01 by weight percent as measured by ICP analysis. In one embodiment, the composition comprising the cathode active material and the oxide bonded to the cathode active material as set forth herein is characterized by a ratio of zirconium: manganese, cobalt, and nickel (Zr/(Mn+Co+Ni) selected from about 0.0034, 0.0036, 0.0039, 0.006, and 0.009 by weight percent as measured by ICP analysis. In an alternative embodiment, the composition comprising the cathode active material and the oxide bonded to the cathode active material as set forth herein is characterized by a ratio of zirconium: manganese, cobalt, and nickel (Zr/(Mn+Co+Ni) of about 0.0030 by weight percent as measured by ICP analysis.

In one embodiment, the composition comprising the cathode active material and the oxide bonded to the cathode active material as set forth herein comprises between about 0.1 weight % and 0.5 weight % of phosphorus as measured by ICP analysis. In one embodiment, the composition comprising the cathode active material and the oxide bonded to the cathode active material as set forth herein comprises between about 0.08 weight % and 0.4 weight % of phosphorus as measured by ICP analysis. In one embodiment, the composition comprising the cathode active material and the oxide bonded to the cathode active material as set forth herein comprises at least 0.1 weight % of phosphorus as measured by ICP analysis. In one embodiment, the composition comprising the cathode active material and the oxide bonded to the cathode active material as set forth herein comprises less than 0.5 weight % of phosphorus as measured by ICP analysis. In one embodiment, the composition comprising the cathode active material and the oxide bonded to the cathode active material as set forth herein comprises about 0.15 weight % of phosphorus as measured by ICP analysis. In one embodiment, the composition comprising the cathode active material and the oxide bonded to the cathode active material as set forth herein comprises about 0.3 weight % of phosphorus as measured by ICP analysis.

In one embodiment, the composition comprising the cathode active material and the oxide bonded to the cathode active material as set forth herein is characterized by a ratio of phosphorus: manganese, cobalt, and nickel (P/(Mn+Co+Ni) of between about 0.001 and 0.01 by weight percent as measured by ICP analysis. In one embodiment, the composition comprising the cathode active material and the oxide bonded to the cathode active material as set forth herein is characterized by a ratio of phosphorus: manganese, cobalt, and nickel (P/(Mn+Co+Ni) of between about 0.002 and 0.06 by weight percent as measured by ICP analysis. In one embodiment, the composition comprising the cathode active material and the oxide bonded to the cathode active material as set forth herein is characterized by a ratio of phosphorus: manganese, cobalt, and nickel (P/(Mn+Co+Ni) of less than about 0.005 by weight percent as measured by ICP analysis. In one embodiment, the composition comprising the cathode active material and the oxide bonded to the cathode active material as set forth herein is characterized by a ratio of phosphorus: manganese, cobalt, and nickel (P/(Mn+Co+Ni) of less than about 0.003 by weight percent as measured by ICP analysis. In one embodiment, the composition comprising the cathode active material and the oxide bonded to the cathode active material as set forth herein is characterized by a ratio of phosphorus: manganese, cobalt, and nickel (P/(Mn+Co+Ni) of less than about 0.002 by weight percent as measured by ICP analysis. In one embodiment, the composition comprising the cathode active material and the oxide bonded to the cathode active material as set forth herein is characterized by a ratio of phosphorus: manganese, cobalt, and nickel (P/(Mn+Co+Ni) of at least about 0.001 by weight percent as measured by ICP analysis. In one embodiment, the composition comprising the cathode active material and the oxide bonded to the cathode active material as set forth herein is characterized by a ratio of phosphorus: manganese, cobalt, and nickel (P/(Mn+Co+Ni) of about 0.0025, 0.0026, and 0.0044 as measured by ICP analysis. In an alternative embodiment, the composition comprising the cathode active material and the oxide bonded to the cathode active material as set forth herein is characterized by a ratio of phosphorus: manganese, cobalt, and nickel (P/(Mn+Co+Ni) of about 0.0043 as measured by ICP analysis.

In one embodiment, the composition comprising the cathode active material and the oxide bonded to the cathode active material as set forth herein comprises between about 5 weight % and 10 weight % of lithium; between about 0.2 weight % and 0.6 weight % of zirconium; and, between about 0.1 weight % and 0.5 weight % of phosphorus as measured by ICP analysis.

In an alternative embodiment, the composition comprising the cathode active material and the oxide bonded to the cathode active material as set forth herein comprises between about 5 weight % and 10 weight % of lithium; between about 0.1 weight % and 0.6 weight % of zirconium; and, between about 0.1 weight % and 0.5 weight % of phosphorus as measured by ICP analysis.

In one embodiment, the composition comprising the cathode active material and the oxide bonded to the cathode active material as set forth herein is characterized by a ratio of lithium:manganese, cobalt, and nickel (Li/(Mn+Co+Ni) of between about 0.1-0.3 by weight percent; a ratio of zirconium:manganese, cobalt, and nickel (Zr/(Mn+Co+Ni) of between about 0.003-0.009 by weight percent; and, a ratio of phosphorus:manganese, cobalt, and nickel (P/(Mn+Co+Ni) of between about 0.002 and 0.06 by weight percent.

In one embodiment, the composition comprising the cathode active material and the oxide bonded to the cathode active material as set forth herein is characterized by a ratio of lithium: manganese, cobalt, and nickel (Li/(Mn+Co+Ni) of between about 0.1-0.3 by weight percent; a ratio of zirconium: manganese, cobalt, and nickel (Zr/(Mn+Co+Ni) of between about 0.0025-0.006 by weight percent; and, a ratio of phosphorus:manganese, cobalt, and nickel (P/(Mn+Co+Ni) of between about 0.002 and 0.06 by weight percent.

In one embodiment, the composition comprising the cathode active material and the oxide bonded to the cathode active material as set forth herein comprises less than about 65 weight % of manganese, cobalt, and nickel. In one embodiment, the composition comprising the cathode active material and the oxide bonded to the cathode active material as set forth herein comprises about 60 weight % of manganese, cobalt, and nickel.

Set forth herein is a composition comprising: a cathode active material; and an oxide bonded to the cathode active material, wherein: the oxide comprises LiZr₂(PO₄)₃ and wherein the composition comprises about 7.5 weight % of lithium, about 0.5 weight % of zirconium, about 0.3 weight % of phosphorus, and about 60 weight % of manganese, cobalt and nickel (Mn+Co+Ni) as measured by ICP analysis.

Set forth herein is a composition comprising: a cathode active material; and an oxide bonded to the cathode active material, wherein: the oxide comprises Li₂ZrO₃ and wherein the composition comprises about 7.5 weight % of lithium about 0.3 weight % of zirconium, and about 60 weight % of manganese, cobalt and nickel (Mn+Co+Ni) as measured by ICP analysis.

Set forth herein is a composition comprising: a cathode active material; and an oxide bonded to the cathode active material, wherein: the oxide comprises Li₃ZrPO₆ and wherein the composition comprises about 7.3 weight % of lithium, about 0.2 weight % of zirconium, about 0.15 weight % of phosphorus, and about 60 weight % of manganese, cobalt and nickel (Mn+Co+Ni) as measured by ICP analysis.

Set forth herein is a composition comprising: a cathode active material; and an oxide bonded to the cathode active material, wherein: the oxide comprises Li₅PZrO₇ and wherein the composition comprises about 7.3 weight % of lithium, about 0.2 weight % of zirconium, about 0.15 weight % of phosphorus, and about 58 weight % of manganese, cobalt and nickel (Mn+Co+Ni) as measured by ICP analysis.

Set forth herein is a composition comprising: a cathode active material; and an oxide bonded to the cathode active material, wherein: the oxide comprises Li₇ZrPO₈ and wherein the composition comprises about 7.5 weight % of lithium, about 0.2 weight % of zirconium, and 0.15 weight % of phosphorus, and about 60 weight % of manganese, cobalt and nickel (Mn+Co+Ni) as measured by ICP analysis.

Set forth herein is a composition comprising: a cathode active material; and an oxide bonded to the cathode active material, wherein: the oxide comprises Li₂₄Zr₃P₁₄O₅₃ and wherein the composition comprises about 7.5 weight % of lithium, about 0.18 weight % of zirconium, and 0.26 weight % of phosphorus, and about 60 weight % of manganese, cobalt and nickel (Mn+Co+Ni) as measured by ICP analysis.

In one embodiment, the composition comprising the cathode active material and the oxide bonded to the cathode active material as set forth herein is characterized by an atomic percent ratio of Zr:Ni between about 0.4 and 4.0 as determined by XPS. In certain embodiments, the composition comprising the cathode active material and the oxide bonded to the cathode active material as set forth herein is characterized by an atomic percent ratio of Zr:Ni in a range selected from between about 0.4 and 1.0, between about 1.0 and 1.5, between about 1.5 and 2.0, between about 2.0 and 2.5, between about 2.5 and 3.0, and between about 3.0 and 3.5 as determined by XPS. In certain embodiments, the composition comprising the cathode active material and the oxide bonded to the cathode active material as set forth herein is characterized by an atomic percent ratio of Zr:Ni of about 0.55, about 1.0, about 1.2, about 3.0, or about 3.2. In an alternative embodiment, the composition comprising the cathode active material and the oxide bonded to the cathode active material as set forth herein is characterized by an atomic percent ratio of Zr:Ni between about 0.2 and 3.0, between about 0.2 and 2.5, between about 0.2 and 2, between about 0.2 and 1.5, between about 0.2 and 1, or between about 0.2 and 0.5 as determined by XPS. In an alternative embodiment, the composition comprising the cathode active material and the oxide bonded to the cathode active material as set forth herein is characterized by an atomic percent ratio of Zr:Ni of about 0.38.

In one embodiment, the composition comprising the cathode active material and the oxide bonded to the cathode active material as set forth herein is characterized by an atomic percent ratio of Zr:Ni between about 0.1 and 3.2 as determined by XPS. In one embodiment, the composition comprising the cathode active material and the oxide bonded to the cathode active material as set forth herein is characterized by an atomic percent ratio of Zr:Ni between about 0.5 and 2.5 as determined by XPS. In one embodiment, the composition comprising the cathode active material and the oxide bonded to the cathode active material as set forth herein is characterized by an atomic percent ratio of Zr:Ni between about 0.7 and 2.5 as determined by XPS. In one embodiment, the composition comprising the cathode active material and the oxide bonded to the cathode active material as set forth herein is characterized by an atomic percent ratio of Zr:Ni between about 1.5 and 2.5 as determined by XPS. In certain embodiments, the composition comprising the cathode active material and the oxide bonded to the cathode active material as set forth herein is characterized by an atomic percent ratio of Zr:Ni of about 0.75, about 1.09, about 1.37, about 1,61, or about 2.35.

In one embodiment, the composition comprising the cathode active material and the oxide bonded to the cathode active material as set forth herein is characterized by an atomic percent ratio of the functional group C—CO₃:Ni between about 0.3 and 20.0 as determined by XPS. In certain embodiments, the composition comprising the cathode active material and the oxide bonded to the cathode active material as set forth herein is characterized by an atomic percent ratio of the functional group C—CO₃:Ni in a range selected from between about 0.4 and 2.0, between about 2.0 and 5.0, between about 5.0 and 10.0, between about 10.0 and 15.0, and between about 15.0 and 20.0 as determined by XPS. In certain embodiments, the composition comprising the cathode active material and the oxide bonded to the cathode active material as set forth herein is characterized by an atomic percent ratio of the functional group C—CO₃:Ni of about 0.40, about 6.8, about 7.0, about 8.2, or about 17.2. In an alternative embodiment, the composition comprising the cathode active material and the oxide bonded to the cathode active material as set forth herein is characterized by an atomic percent ratio of the functional group C—CO₃:Ni of about 1.6.

In one embodiment, the composition comprising the cathode active material and the oxide bonded to the cathode active material as set forth herein is characterized by an atomic percent ratio of the functional group O-Me:total oxygen between about 0.04 and 0.4 as determined by XPS. In certain embodiments, the composition comprising the cathode active material and the oxide bonded to the cathode active material as set forth herein is characterized by an atomic percent ratio of the functional group O-Me:total oxygen in a range selected from between about 0.04 and 0.08, between about 0.08 and 0.1, between about 0.1 and 0.3, and between about 0.3 and 0.5 as determined by XPS. Herein “Me” refers to methyl and “O-Me” refers to methoxy. In certain embodiments, the composition comprising the cathode active material and the oxide bonded to the cathode active material as set forth herein is characterized by an atomic percent ratio of the functional group O-Me:total oxygen of about 0.057, about 0.08, about 0.18, or about 0.38. In certain embodiments, the composition comprising the cathode active material and the oxide bonded to the cathode active material as set forth herein is characterized by an atomic percent ratio of the functional group O-Me:total oxygen of about 0.21.

Set forth herein is a composition comprising: a cathode active material; and an oxide bonded to the cathode active material, wherein: the oxide comprises LiZr₂(PO₄)₃ and wherein the composition is characterized by an atomic percent ratio of Zr:Ni of about 0.55, an atomic percent ratio of the functional group C—CO₃:Ni of about 0.40, and an atomic percent ratio of the functional group O-Me:total oxygen of about 0.4 as measured by XPS.

Set forth herein is a composition comprising: a cathode active material; and an oxide bonded to the cathode active material, wherein: the oxide comprises Li₃ZrPO₆ and wherein the composition is characterized by an atomic percent ratio of Zr:Ni of about 1.3, an atomic percent ratio of the functional group C—CO₃:Ni of about 6.9, and an atomic percent ratio of the functional group O-Me:total oxygen of about 0.08 as measured by XPS.

Set forth herein is a composition comprising: a cathode active material; and an oxide bonded to the cathode active material, wherein: the oxide comprises Li₅ZrPO₇ and wherein the composition is characterized by an atomic percent ratio of Zr:Ni of about 1.1, an atomic percent ratio of the functional group C-CO₃:Ni of about 8.2, and an atomic percent ratio of the functional group O-Me:total oxygen of about 0.08 as measured by XPS.

Set forth herein is a composition comprising: a cathode active material; and an oxide bonded to the cathode active material, wherein: the oxide comprises Li₇ZrPO₈ and wherein the composition is characterized by an atomic percent ratio of Zr:Ni of about 3.0, an atomic percent ratio of the functional group C—CO₃:Ni of about 17.2, and an atomic percent ratio of the functional group O-Me:total oxygen of about 0.06 as measured by XPS.

Set forth herein is a composition comprising: a cathode active material; and an oxide bonded to the cathode active material, wherein: the oxide comprises Li₂ZrO₃ and wherein the composition is characterized by an atomic percent ratio of Zr:Ni of about 3.2, an atomic percent ratio of the functional group C—CO₃:Ni of about 7.0, and an atomic percent ratio of the functional group O-Me:total oxygen of about 0.2 as measured by XPS.

Set forth herein is a composition comprising: a cathode active material; and an oxide bonded to the cathode active material, wherein: the oxide comprises Li₂₄Zr₃P₁₄O₅₃ and wherein the composition is characterized by an atomic percent ratio of Zr:Ni of about 0.38, an atomic percent ratio of the functional group C—CO₃:Ni of about 1.6, and an atomic percent ratio of the functional group O-Me:total oxygen of about 0.21 as measured by XPS.

Set forth herein is a composition comprising: a cathode active material; and an oxide bonded to the cathode active material, wherein: the oxide comprises LiZr₂(PO₄)O₃ and wherein the composition is characterized by an atomic percent ratio of Zr:Ni between about 0.1 and 2, In one embodiment, the atomic percent ratio of Zr:Ni is about 0.75.

Set forth herein is a composition comprising: a cathode active material; and an oxide bonded to the cathode active material, wherein: the oxide comprises Li₂ZrO₃ and wherein the composition is characterized by an atomic percent ratio of Zr:Ni between about 1.40 and 4.5, In one embodiment, the atomic percent ratio of Zr:Ni is about 2.4.

Set forth herein is a composition comprising: a cathode active material; and an oxide bonded to the cathode active material, wherein: the oxide comprises Li₃ZrPO₆ and wherein the composition is characterized by an atomic percent ratio of Zr:Ni between about 0.15 and 2.2, In one embodiment, the atomic percent ratio of Zr:Ni is about 1.4.

Set forth herein is a composition comprising: a cathode active material; and an oxide bonded to the cathode active material, wherein: the oxide comprises Li₅PZrO₇ and wherein the composition is characterized by an atomic percent ratio of Zr:Ni between about 0.1 and 2.0, In one embodiment, the atomic percent ratio of Zr:Ni is about 1.1.

Set forth herein is a composition comprising: a cathode active material; and an oxide bonded to the cathode active material, wherein: the oxide comprises Li₇ZrO₈ and wherein the composition is characterized by an atomic percent ratio of Zr:Ni between about 0.14 and 3.2, In one embodiment, the atomic percent ratio of Zr:Ni is about 1.6.

Set forth herein is a composition comprising: a cathode active material; and an oxide bonded to the cathode active material, wherein: the oxide comprises LiZr₂(PO₄)₃ and wherein the composition comprises about 7.5 weight % of lithium, about 0.5 weight % of zirconium, and about 0.3 weight % of phosphorus as measured by ICP analysis and wherein the composition is characterized by an atomic percent ratio of Zr:Ni of about 0.55, an atomic percent ratio of the functional group C—CO₃:Ni of about 0.40, and an atomic percent ratio of the functional group O-Me:total oxygen of about 0.4 as measured by XPS.

Set forth herein is a composition comprising: a cathode active material; and an oxide bonded to the cathode active material, wherein: the oxide comprises Li₂ZrO₃ and wherein the composition comprises about 7.5 weight % of lithium and about 0.3 weight % of zirconium as measured by ICP analysis and wherein the composition is characterized by an atomic percent ratio of Zr:Ni of about 3.2, an atomic percent ratio of the functional group C-CO₃:Ni of about 7.0, and an atomic percent ratio of the functional group O-Me:total oxygen of about 0.2 as measured by XPS.

Set forth herein is a composition comprising: a cathode active material; and an oxide bonded to the cathode active material, wherein: the oxide comprises Li₃ZrPO₆ and wherein the composition comprises about 7.3 weight % of lithium, about 0.2 weight % of zirconium, and about 0.15 weight % of phosphorus as measured by ICP analysis and wherein the composition is characterized by an atomic percent ratio of Zr:Ni of about 1.3, an atomic percent ratio of the functional group C—CO₃:Ni of about 6.9, and an atomic percent ratio of the functional group O-Me:total oxygen of about 0.08 as measured by XPS.

Set forth herein is a composition comprising: a cathode active material; and an oxide bonded to the cathode active material, wherein: the oxide comprises Li₅PZrO₇ and wherein the composition comprises about 7.3 weight % of lithium, about 0.2 weight % of zirconium, and about 0.15 weight % of phosphorus as measured by ICP analysis and wherein the composition is characterized by an atomic percent ratio of Zr:Ni of about 1.1, an atomic percent ratio of the functional group C—CO₃:Ni of about 8.2, and an atomic percent ratio of the functional group O-Me:total oxygen of about 0.08 as measured by XPS.

Set forth herein is a composition comprising: a cathode active material; and an oxide bonded to the cathode active material, wherein: the oxide comprises Li₇ZrPO₈ and wherein the composition comprises about 7.5 weight % of lithium, about 0.2 weight % of zirconium, and about 0.15 weight % of phosphorus as measured by ICP analysis and wherein the composition is characterized by an atomic percent ratio of Zr:Ni of about 3.0, an atomic percent ratio of the functional group C—CO₃:Ni of about 17.2, and an atomic percent ratio of the functional group O-Me:total oxygen of about 0.06 as measured by XPS.

Set forth herein is a composition comprising: a cathode active material; and an oxide bonded to the cathode active material, wherein: the oxide comprises Li₂₄Zr₃P₁₄O₅₃ and wherein the composition comprises about 7.5 weight % of lithium, about 0.18 weight % of zirconium, and about 0.26 weight % of phosphorus as measured by ICP analysis and wherein the composition is characterized by an atomic percent ratio of Zr:Ni of about 0.38, an atomic percent ratio of the functional group C—CO₃:Ni of about 1.62, and an atomic percent ratio of the functional group O-Me:total oxygen of about 0.21 as measured by XPS.

In one embodiment, including any of the foregoing, the XPS is taken of a loose powder of the composition and the scanned area diameter of the powder taken during the XPS is about 400 μm.

In some other examples, set forth herein is a solid-state cathode comprising a cathode active material and oxide as set forth herein bonded to the cathode active material.

In certain embodiments, including any of the foregoing, the solid-state cathode comprises a solid-state electrolyte selected from the group consisting of Li₂S—SiS₂, Li₂S—SiS₂—LiI, Li₂S—SiS₂—Li₃MO₄, Li₂S—SiS₂—Li₃MO₃, Li₂S—P₂S₅—LiI, and LATS, where M is a member selected from the group consisting of Si, P, Ge, B, Al, Ga, and In.

In certain embodiments, including any of the foregoing, the solid-state cathode comprises LSTPS or LPSI.

In some other examples, set forth herein is a battery comprising a solid-state cathode set forth herein, a solid separator and an anode.

In certain embodiments, including any of the foregoing, the cathode active material in the battery is selected from LiMPO₄ (M═Fe, Ni, Co, Mn), LiₓTi_{y}O_{z}, wherein x is from 0 to 8, y is from 1 to 12, z is from 1 to 24, LiMn₂O₄, LiMn₂ₐNiₐO₄, wherein a is from 0 to 2, LiCoO₂, Li(NiCoMn)O₂, Li(NiCoAl)O₂, and a nickel cobalt aluminum oxide.

In certain embodiments, including any of the foregoing, the cathode active material in the battery is selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1. In certain embodiments, including any of the foregoing, the cathode active material is LiNiₓMn_{y}Co_{z}O₂, x+y+z=1, 0≤x≤1, 0≤y≤1, and 0≤z≤1. In certain examples, the cathode active material is LiNiₓMn_{y}Co_{z}O₂, x is 0.8, y is 0.1, and z is 0.1. In certain other examples, the coated cathode active material is LiNiₓMn_{y}Co_{z}O₂, x is 0.6, y is 0.2, and z is 0.2. In some other examples, the coated cathode active material is LiNiₓMn_{y}Co_{z}O₂, x is 0.5, y is 0.3, and z is 0.2. In other examples, the coated cathode active material is LiNiₓMn_{y}Co_{z}O₂, x is ⅓, y is ⅓, and z is ⅓. In certain embodiments, the coated cathode active material is selected from LiMn₂O₄, LiCoO₂, Li(NiCoMn)O₂, and Li(NiCoAl)O₂.

In certain embodiments, including any of the foregoing, the cathode active material in the battery is selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In one embodiment, including any of the foregoing, the cathode active material in the battery is LiNiₓMn_{y}Co_{z}O₂, x+y+z=1, 0≤x≤1, 0≤y≤1, and 0≤z≤1.

In one embodiment, including any of the foregoing, the cathode active material in the battery is LiNiₓMn_{y}Co_{z}O₂, x is 0.8, y is 0.1, and z is 0.1.

In one embodiment, including any of the foregoing, the cathode active material in the battery is LiNiₓMn_{y}Co_{z}O₂, x is 0.6, y is 0.2, and z is 0.2.

In one embodiment, including any of the foregoing, the cathode active material in the battery is LiNiₓMn_{y}Co_{z}O₂, x is 0.5, y is 0.3, and z is 0.2.

In certain embodiments, including any of the foregoing, the cathode active material in the battery is LiNiₓMn_{y}Co_{z}O₂, x+y+z=1, 0.8≤x≤0.97, 0≤y≤0.2, and 0≤z≤0.2. In certain embodiments, including any of the foregoing, the cathode active material in the battery is LiNiₓMn_{y}Co_{z}O₂, x+y+z=1, 0.8≤x≤0.95, 0≤y≤0.2, and 0≤z≤0.2. In certain embodiments, including any of the foregoing, the cathode active material in the battery is LiNiₓMn_{y}Co_{z}O₂, x+y+z=1, 0.8≤x≤0.9, 0≤y≤0.2, and 0≤z≤0.2. In certain embodiments, including any of the foregoing, the cathode active material in the battery is LiNiₓMn_{y}Co_{z}O₂, x+y+z=1, 0.8≤x≤0.85, 0≤y≤0.2, and 0≤z≤0.2. In certain embodiments, including any of the foregoing, the cathode active material in the battery is LiNiₓMn_{y}Co_{z}O₂, x+y+z=1, 0.8≤x≤0.83, 0≤y≤0.2, and 0≤z≤0.2.

In certain embodiments, including any of the foregoing, the cathode active material is a member of the NMC class of cathode active materials, for example, LiNiCoMnO₂. In certain embodiments, including any of the foregoing, the cathode active material is a member of the LFP class of cathode active materials, for example, LiFePO₄/C. In certain embodiments, including any of the foregoing, the cathode active material is a member of the LNMO class of cathode active materials, for example, LiNi_{0.5}Mn_{1.5}O₄ or LiNi_{0.5}Mn_{1.5}O₂. In certain embodiments, including any of the foregoing, the cathode active material is a member of the NCA class of cathode active materials, for example, LiMn₂O₄. In certain embodiments, including any of the foregoing, the cathode active material is a member of the LMO class of cathode active materials, for example, LiMn₂O₄. In certain embodiments, including any of the foregoing, the cathode active material is a member of the LCO class of cathode active materials, for example, LiCoO₂.

In one embodiment, including any of the foregoing, the cathode active material in the battery is LiNiₓMn_{y}Co_{z}O₂, x is ⅓, y is ⅓, and z is ⅓.

In one embodiment, including any of the foregoing, the cathode active material in the battery is selected from LiMn₂O₄, LiCoO₂, Li(NiCoMn)O₂, and Li(NiCoAl)O₂.

In certain embodiments, including any of the foregoing, the cathode active material in the battery is selected from LiMPO₄ (M=Fe, Ni, Co, Mn), LiₓTi_{y}O_{z}, wherein x is from 0 to 8, y is from 1 to 12, z is from 1 to 24, LiMn₂ₐNiₐO₄, wherein a is from 0 to 2, and nickel cobalt aluminum oxides.

### Non-Limiting Embodiments

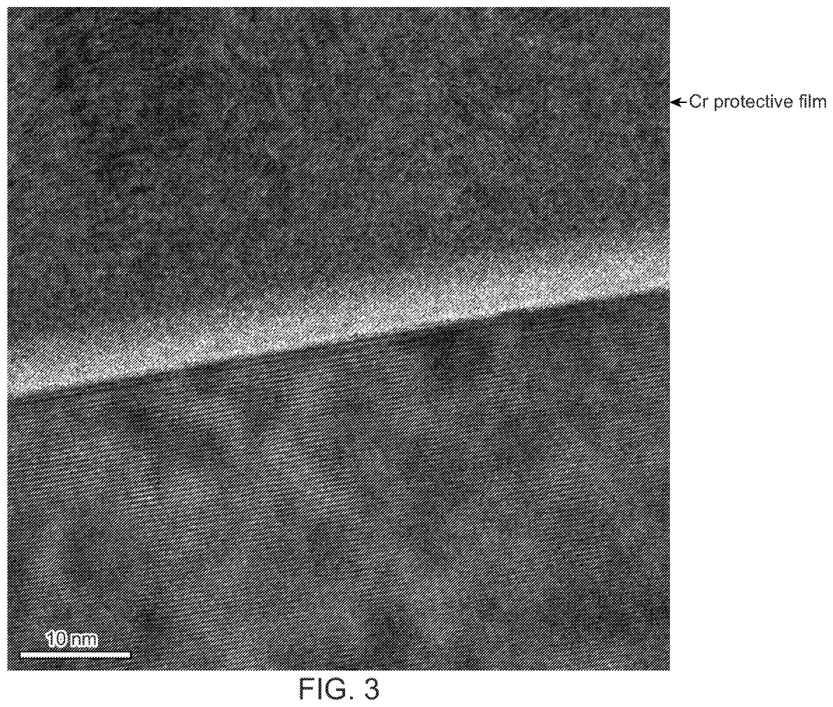

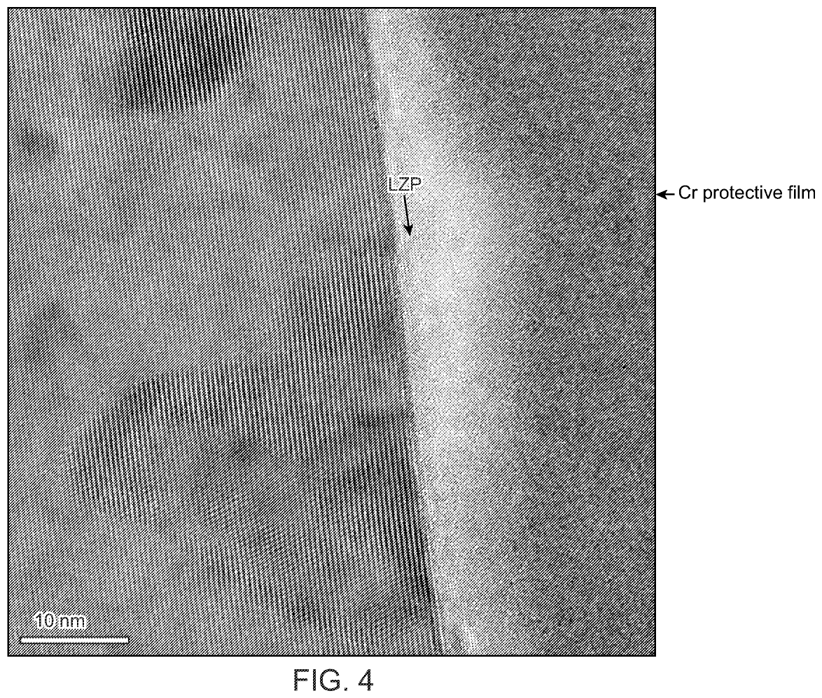

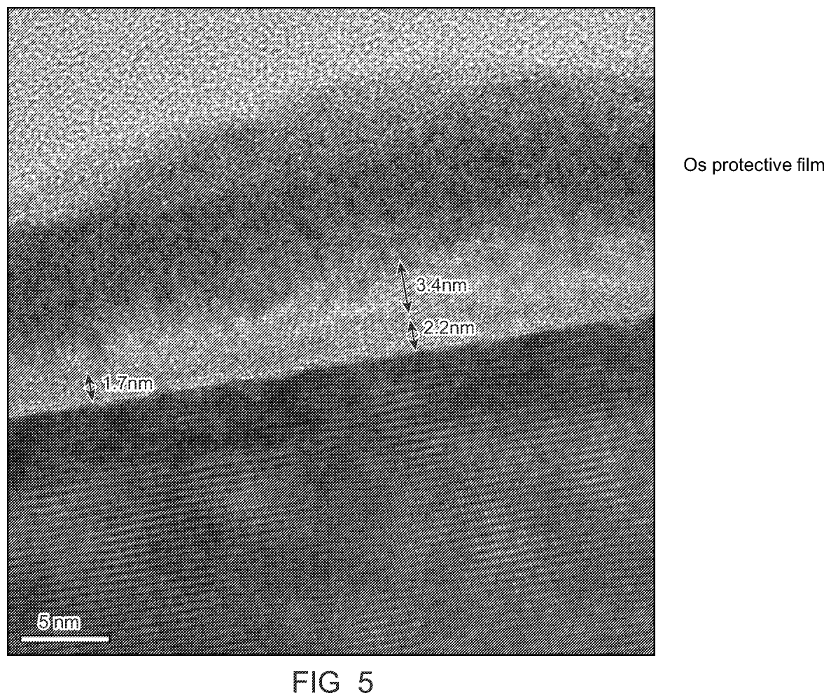

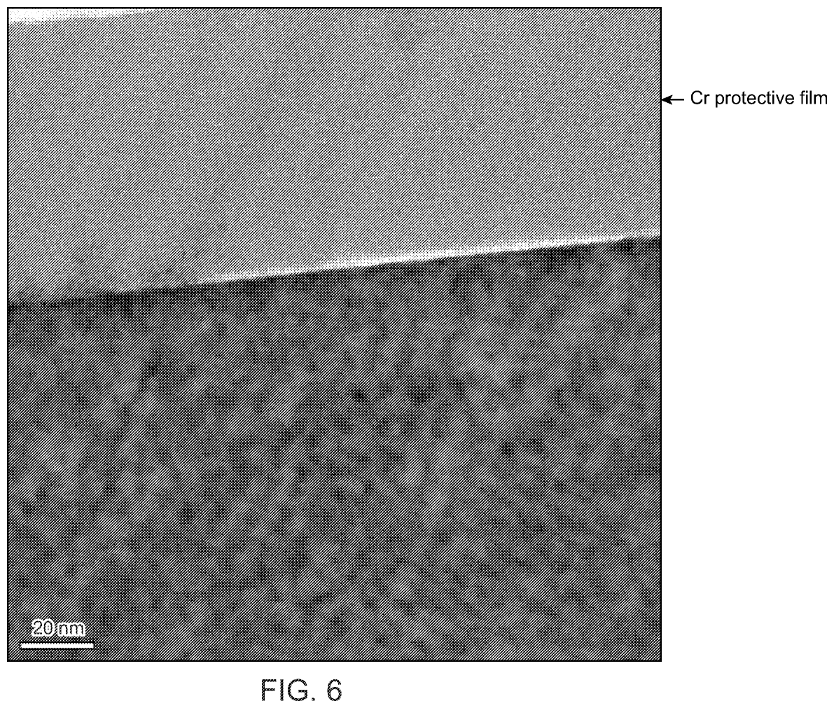

The present disclosure provides at least the following non-limiting embodiments:
(a) A composition comprising:
   a cathode active material; and
   at least one oxide bonded to the cathode active material;
   wherein the at least one oxide bonded to the cathode active material comprises lithium (Li), oxygen (O), and at least one of zirconium (Zr) and phosphorus (P);
   wherein the molar ratios of Li, Zr, P, and O are represented by the formula LiₓZr_{y}PₐO_{d}, wherein 0.05≤x≤25.0, 0≤y≤5.0, 0≤a≤16.0; and 2.0≤d≤55.0; and
   wherein subscripts x, y, a, and d, are selected so the at least one oxide is charge neutral and y and a are not both zero; and
   wherein the composition has a ratio of Zr:Ni, as measured by x-ray photoelectron spectroscopy (XPS) of 0.3 to 3.2.
(b) The composition of (a) wherein the molar ratios of Li, Zr, P, and O are represented by the formula LiₓZr_{y}PₐO_{d}, wherein 0.05≤x≤7.0, 0≤y≤3.0, 0≤a≤6.0; and 2.0≤d≤20.0;
(c) A composition comprising:
   a cathode active material having a surface and an oxide bonded to the surface;
   wherein the oxide is selected from the group consisting of:
   amorphous lithium zirconium oxide;
   amorphous lithium zirconium phosphorus oxide; and
   combinations thereof;
   wherein the composition has a ratio of Zr:Ni, as measured by x-ray photoelectron spectroscopy (XPS) of 0.3 to 3.2.
(d) The composition of claim (c) comprising:
   a cathode active material having a surface and an oxide bonded to the surface;
   wherein the oxide is selected from the group consisting of:
   LiZr₂(PO₄)₃;
   Li₂ZrO₃;
   Li₃ZrPO₆;
   Li₅PZrO₇;
   Li₇ZrPO₈;
   Li₂₄Zr₃P₁₄O₅₃; and
   combinations thereof;
   wherein the composition has a ratio of Zr:Ni, as measured by x-ray photoelectron spectroscopy (XPS) of 0.3 to 3.2.
(e) The composition of any one of embodiments (a)-(d), wherein the oxide is amorphous.
(f) The composition of any one of embodiments (a)-(e), wherein the oxide is crystalline.
(g) The composition of any one of embodiments (a)-(b) and (e)-(f), wherein at least subscript x and subscript d are not 0.
(h) The composition of any one of embodiments (a)-(b) and (e)-(g), wherein subscript y is not 0.
(i) The composition of embodiment any one of embodiments (a)-(b) and (e)-(g), wherein subscript y and subscript a are not 0.
(j) The composition of any one of embodiments (a)-(b) and (e)-(i), wherein at least one of subscript x or subscript a is not equal to 0.
(k) The composition of any one of embodiments (a)-(b) and (e)-(f), wherein the oxide comprises a compound of the formula LiₓZr_{y}PₐO_{d}, wherein 0.05≤x≤1.5, 1≤y≤3, 1.0≤a≤6.0; and 2.0≤d≤20.0.
(l) The composition of any one of embodiments (a)-(b) and (e)-(f), wherein the oxide comprises a compound of the formula LiₓZr_{y}PₐO_{d}, wherein 0.05≤x≤1.5, 1≤y≤3, 2.0≤a≤4.0; and 10.0≤d≤14.0.
(m) The composition of any one of embodiments (a)-(b) and (e)-(f), wherein the oxide comprises a compound of the formula LiₓZr_{y}PₐO_{d}, wherein 20.0≤x≤25.0, 2.0≤y≤5.0, 10.0≤a≤16.0; and 50.0≤d≤55.0.
(n) The composition of any one of embodiments (a)-(b) and (e)-(f), wherein the oxide a compound of the formula LiₓZr_{y}O_{d}, wherein 1.0≤x≤3, 0≤y≤2, and 2.0≤d≤5.0.
(o) The composition of any one of embodiments (a)-(b) and (e)-(f), wherein the oxide a compound of the formula LiₓPₐO_{d}, wherein 2.0≤x≤4, 0≤a≤2.0, and 2.0≤d≤5.0.
(p) The composition of any one of embodiments (a)-(b) and (d)-(f), wherein the oxide comprises a compound selected from LiZr₂(PO₄)₃, Li₃ZrPO₆, Li₅PZrO₇, Li₇ZrPO₈, and Li₂₄Zr₃P₁₄O₅₃.
(q) The composition of embodiment (p), wherein the oxide comprises LiZr₂(PO₄)₃.
(r) The composition of any one of embodiments (a)-(b) and (d)-(f), wherein the oxide comprises Li₃PO₄.
(s) The composition of any one of embodiments (a)-(f), wherein the oxide comprises Li₂ZrO₃.
(t) The composition of any one of embodiments (a)-(s), wherein the oxide is a product of a reaction mixture of 1) LiOH; and 2) a zirconium precursor and/or a phosphorus precursor.
(u) The composition of embodiment (t), wherein the molar ratio of Li:Zr in the reaction mixture is a ratio in the range of about 1:3 to 1:1.
(v) The composition of embodiment (t), wherein the molar ratio of Li:Zr in the reaction mixture is in the range of about 1:1 to 3:1.
(w) The composition of embodiment (t), wherein the molar ratio of Li:Zr in the reaction mixture is a ratio in the range of about 4:1 to 6:1.
(x) The composition of embodiment (t), wherein the molar ratio of Li:Zr in the reaction mixture is in the range of about 6:1 to 8:1.
(y) The composition of embodiment (t), wherein the molar ratio of Li:Zr in the reaction mixture is in the range of about 8:1 to 10:1.
(z) The composition of any one of embodiments (t)-(y), wherein the molar ratio of Li:P in the reaction mixture is a ratio in the range of about 3:1 to 1:1.
(aa) The composition of any one of embodiments (t)-(y), wherein the molar ratio of Li:P in the reaction mixture is a ratio in the range of about 1:3 to 1:1.
(bb) The composition of any one of embodiments (t)-(y), wherein the molar ratio of Li:P in the reaction mixture is in the range of about 5:1 to 7:1.
(cc) The composition of any one of embodiments (t)-(y), wherein the molar ratio of Li:P in the reaction mixture is a ratio in the range of about 9:1 to 11:1.
(dd) The composition of any one of embodiments (t)-(y), wherein the molar ratio of Li:P in the reaction mixture is about 13:1 to 15:1.
(ee) The composition of any one of embodiments (t)-(dd), wherein the molar ratio of Zr:P in the reaction mixture is a ratio in the range of about 3:16 to 3:10.
(ff) The composition of any one of embodiments (t)-(dd), wherein the molar ratio of Zr:P in the reaction mixture is a ratio in the range of about 1.3:1 to 1:1.
(gg) The composition of any one of embodiments (t)-(dd), wherein the molar ratio of Zr:P in the reaction mixture is in the range of about 1:1 to 3:1.
(hh) The composition of any one of embodiments (t)-(dd), wherein the molar ratio of Zr:P in the reaction mixture is a ratio of about 1.3:1.
(ii) The composition of any one of embodiments (t)-(dd), wherein the molar ratio of Zr:P in the reaction mixture is a ratio of 2.0.
(jj) The composition of embodiment (t), wherein the molar ratio in the reaction mixture of Li and Zr:P is about 70:30 to 65:35.
(kk) The composition of embodiment (t), wherein the molar ratio in the reaction mixture of Li and Zr:P is about 75:25 to 80:20.
(ll) The composition of embodiment (t), wherein the molar ratio in the reaction mixture of Li and Zr:P is about 80:20 to 90:10.
(mm) The composition of embodiment (t), wherein the molar ratio in the reaction mixture of Li and Zr:P is about 90:10 to 85:15.
(nn) The composition of embodiment (t), wherein the molar ratio in the reaction mixture of Li and Zr:P is about 95:5 to 90:10.
(oo) The composition of embodiment (t), wherein the molar ratio in the reaction mixture of Li and Zr:P is about 90:10 to 95:5.
(pp) The composition of any one of embodiments (a)-(b), (e)-(m), (o)-(r), and (t)-(oo), wherein the oxide is a product of a reaction mixture of LiOH and a phosphorus precursor.
(qq) The composition of any one of embodiments (a)-(n), (p)-(q), and (s)-(oo), wherein the oxide is a product of a reaction mixture of LiOH and a zirconium precursor.
(rr) The composition of any one of embodiments (r)-(oo) and (qq), wherein the zirconium precursor is selected from zirconium propoxide, zirconium ethoxide, zirconium methoxide, and zirconium butoxide.
(ss) The composition of embodiment (rr), wherein the zirconium precursor is zirconium butoxide.
(tt) The composition of any one of embodiment (r)-(pp), wherein the phosphorus precursor is selected from P₂O₅, H₃PO₄, (NH₄)₃PO₄.
(uu) The composition of embodiment (tt), wherein the phosphorus precursor is P₂O₅.
(vv) The composition of any one of embodiment (a)-(uu), wherein the oxide is lattice-matched with the cathode active material.
(ww) The composition of embodiment (vv), wherein the oxide has a surface which is amorphous.
(xx) The composition of embodiment (vv) or (ww), wherein the oxide has a surface which is crystalline.
(yy) The composition of any one of embodiment (a)-(e) and (f)-(ww), having an interface substantially as show in FIG. 3, FIG. 4, FIG. 5, or FIG. 6.
(zz) The composition of any one of embodiment (a)-(d), (f)-(vv) and (xx), having an interface substantially as show in FIG. 2, FIG. 4, FIG. 5, or FIG. 6.
(aaa) The composition of any one of embodiments (a)-(zz), wherein the cathode active material is selected from LiMPO₄ (M═Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.
(bbb) The composition of any one of embodiments (a)-(aaa), wherein the cathode active material is LiNiₓMn_{y}Co_{z}O₂, x+y+z=1, 0≤x≤1, 0≤y≤1, and 0≤z≤1 and wherein x+y+z=1.
(ccc) The composition of embodiment (bbb), wherein the cathode active material is LiNiₓMn_{y}Co_{z}O₂, x is 0.8, y is 0.1, and z is 0.1.
(ddd) The composition of embodiment (bbb), wherein the cathode active material is LiNiₓMn_{y}Co_{z}O₂, x is 0.6, y is 0.2, and z is 0.2.
(eee) The composition of embodiment (bbb), wherein the cathode active material is LiNiₓMn_{y}Co_{z}O₂, x is 0.5, y is 0.3, and z is 0.2.
(fff) The composition of embodiment (bbb), wherein the cathode active material is LiNiₓMn_{y}Co_{z}O₂, x is ⅓, y is ⅓, and z is ⅓.
(ggg) The composition of embodiment (bbb), wherein the cathode active material is LiNiₓMn_{y}Co_{z}O₂, x+y+z=1, 0.8≤x≤0.97, 0≤y≤0.2, and 0≤z≤0.2.
(hhh) The composition of embodiment (bbb), wherein the cathode active material is LiNiₓMn_{y}Co_{z}O₂, x+y+z=1, 0.8≤x≤0.90, 0≤y≤0.2, and 0≤z≤0.2.
(iii) The composition of embodiment (bbb), wherein the cathode active material is LiNiₓMn_{y}Co_{z}O₂, x+y+z=1, 0.8≤x≤0.85, 0≤y≤0.2, and 0≤z≤0.2.
(jjj) The composition of embodiment (bbb), wherein the cathode active material is LiNiₓMn_{y}Co_{z}O₂, x+y+z=1, 0.8≤x≤0.83, 0≤y≤0.2, and 0≤z≤0.2.
(kkk) The composition of embodiment (bbb), wherein the cathode active material is Li(NiCoMn)O₂.
(lll) The composition of any one of embodiments (a)-(zz), wherein the cathode active material is selected from a member from the NMC class of cathode active materials; LFP class of cathode active materials; LNMO class of cathode active materials; NCA class of cathode active materials; LMO class of cathode active materials; LCO class of cathode active materials.
(mmm) The composition of any one of embodiments (a)-(n), (p)-(q), (s)-(oo) and (qq)-(lll), characterized by an atomic percent ratio of Zr:Ni as determined by XPS between about 0.4 to 4.
(nnn) The composition of any one of embodiments (a)-(n), (p)-(q), (s)-(oo) and (qq)-(lll), characterized by an atomic percent ratio of Zr:Ni as determined by XPS between about 0.2 to 2.
(ooo) The composition of embodiment (mmm), characterized by an atomic percent ratio of Zr:Ni of about 0.55, about 1.1, about 1.3, about 3.0, or about 3.2.
(ppp) The composition of embodiment (nnn), characterized by an atomic percent ratio of Zr:Ni of about 0.38.
(qqq) The composition of embodiment (mmm), characterized by an atomic percent ratio of Zr:Ni between about 0.5 and 2.5.
(rrr) The composition of embodiment (mmm), characterized by an atomic percent ratio of Zr:Ni between about 0.7 and 1.5.
(sss) The composition of embodiment (mmm), characterized by an atomic percent ratio of Zr:Ni between about 1.5 and 2.5.
(ttt) The composition of embodiment (mmm), characterized by an atomic percent ratio of Zr:Ni of about 0.75, 1.09, 1.37, 1.61, and 2.35.
(uuu) The composition of any one of embodiments (a)-(ttt), characterized by an atomic percent ratio of C—CO₃:Ni as determined by XPS of about 0.3 to 20.
(vvv) The composition of embodiment (uuu), characterized by an atomic percent ratio of C—CO₃:Ni as determined by XPS of about 0.4, about 6.8, about 7.0, about 8.2, or about 17.2.
(www) The composition of embodiment (uuu), characterized by an atomic percent ratio of C—CO₃:Ni as determined by XPS of about 1.6.
(xxx) The composition of any one of embodiments (a)-(www), characterized by an atomic percent ratio of oxygen in O—CH₃:total oxygen in the oxide bonded to the cathode active materials determined by XPS of about 0.04 to 0.4.
(yyy) The composition of embodiment (xxx), characterized by an atomic percent ratio of oxygen in O—CH₃:total oxygen as determined by XPS of about 0.057, about 0.080, about 0.19, or about 0.39.
(zzz) The composition of embodiment (xxx), characterized by an atomic percent ratio of oxygen in O—CH₃:total oxygen as determined by XPS of about 0.21.
(aaaa) The composition of any one of embodiments (a)-(zzz), wherein the composition comprises between about 5 weight % and 10 weight % of lithium as measured by inductively coupled plasma (ICP) analysis.
(bbbb) The composition of any one of embodiments (a)-(n), (p)-(q), (s)-(oo) and (qq)-(aaaa), wherein the composition comprises less than about 1 weight % of zirconium as measured by inductively coupled plasma (ICP) analysis.
(cccc) The composition of any one of embodiments (a)-(n), (p)-(q), (s)-(oo) and (qq)-(aaaa), wherein the composition comprises at least about 0.1 weight % of zirconium as measured by inductively coupled plasma (ICP) analysis.
(dddd) The composition of any one of embodiments (a)-(n), (p)-(q), (s)-(oo) and (qq)-(aaaa), wherein the composition comprises between about 0.1 weight % and 0.7% of zirconium as measured by inductively coupled plasma (ICP) analysis.
(eeee) The composition of any one of embodiments (a)-(m), (o)-(r), (t)-(pp), and (rr)-(dddd), wherein the composition comprises less than about 0.5 weight % of phosphorus as measured by inductively coupled plasma (ICP) analysis.
(ffff) The composition of any one of embodiments (a)-(m), (o)-(r), (t)-(pp), and (rr)-(dddd), wherein the composition comprises at least 0.1 weight % of phosphorus as measured by inductively coupled plasma (ICP) analysis.
(gggg) The composition of any one of embodiments (a)-(m), (o)-(r), (t)-(pp), and (rr)-(dddd), wherein the composition comprises between about 0.08 weight % and 0.4% of phosphorus as measured by inductively coupled plasma (ICP) analysis.
(hhhh) The composition of any one of embodiments (a)-(gggg), wherein the composition comprises less than about 65 weight % of manganese, cobalt, and nickel as measured by inductively coupled plasma (ICP) analysis.
(iiii) The composition of any one of embodiments (a)-(gggg), wherein the composition comprises at least about 55 weight % of manganese, cobalt, and nickel as measured by inductively coupled plasma (ICP) analysis.
(jjjj) The composition of any one of claims embodiments (a)-(m), (o)-(r), (t)-(pp), and (rr)-(iiii), wherein the ratio of phosphorus to manganese, cobalt, and nickel (P: Mn+Co+Ni) is at least about 0.001 by weight percent as measured by inductively coupled plasma (ICP) analysis.
(kkkk) The composition of any one of claims (a)-(m), (o)-(r), (t)-(pp), and (rr)-(jjjj), wherein the ratio of zirconium to manganese, cobalt, and nickel (Zr: Mn+Co+Ni) is at least about 0.002 by weight percent as measured by inductively coupled plasma (ICP) analysis.
(llll) The composition of any one of embodiments (a)-(kkkk), wherein the ratio of lithium to manganese, cobalt, and nickel (Li:Mn+Co+Ni) is at least about 0.08 by weight percent as measured by inductively coupled plasma (ICP) analysis.
(mmmm) An oxide having the following formula, LiₓZr_{y}PₐO_{d}, wherein 0.05≤x≤25.0, 0≤y≤5.0, 0≤a≤16.0; and 2.0≤d≤55.0; wherein the formula is charge neutral and wherein the oxide is bonded to cathode active material selected from lithium cobalt oxide (LCO), lithium nickel cobalt aluminum oxide (NCA), lithium nickel manganese cobalt oxide (NMC), lithium iron phosphate (LFP), and combinations thereof.
(nnnn) The oxide of embodiment (mmmm), wherein the compound has the formula LiₓZr_{y}PₐO_{d}, wherein 20.0≤x≤25.0, 2.0≤y≤5.0, 10.0≤a≤16.0; and 50.0≤d≤55.0.
(oooo) An oxide having the following formula, LiₓZr_{y}PₐO_{d}, wherein 0.5≤x≤7, 0≤y≤3, 0≤a≤6; and 2.0≤d≤20; wherein the formula is charge neutral and wherein the oxide is bonded to cathode active material selected from lithium cobalt oxide (LCO), lithium nickel cobalt aluminum oxide (NCA), lithium nickel manganese cobalt oxide (NMC), lithium iron phosphate (LFP), and combinations thereof.
(pppp) The oxide of embodiment (oooo), wherein the oxide comprises a compound of formula LiₓZr_{y}PₐO_{d}, wherein 0.05≤x≤1.5, 1≤y≤3, 1.0≤a≤6.0; and 2.0≤d≤20.
(qqqq) The oxide of embodiment (mmmm), wherein the compound is Li₂₄Zr₃P₁₄O₅₃.
(rrrr) The oxide of embodiment (oooo), wherein the compound is selected from LiZr₂(PO₄)₃, Li₃ZrPO₆, Li₅PZrO₇, and Li₇ZrPO₈.
(ssss) The oxide of embodiment (rrrr), wherein the compound is LiZr₂(PO₄)₃.
(tttt) The oxide of embodiment (rrrr), wherein the compound is Li₃PO₄.
(uuuu) The oxide of embodiment (rrrr), wherein the compound is Li₂ZrO₃.
(vvvv) The oxide of any one of embodiments (mmmm)-(uuuu), wherein the cathode active material is lithium nickel manganese cobalt oxide (NMC).
(wwww) The composition of any one of embodiments (a)-(llll) or the oxide of any one of embodiments (mmmm)-(vvvv), wherein the oxide bonded to the cathode active material is a coating on the cathode active material.
(xxxx) A solid-state cathode comprising the composition of any one of embodiments (a)-(llll) or the oxide of any one of embodiments (mmmm)-(vvvv).
(yyyy) A solid-state battery comprising the solid-state cathode of embodiment (xxxx), a solid-state electrolyte, and an anode active material is selected from lithium metal, lithium titanate (Li₂TiO₃, LTO), carbon/graphite (C), silicon (Si)/silicon oxide, lithium (Li), zinc (Zn), aluminum (Al), magnesium (Mg), alloys thereof, and combinations thereof.
(zzzz) The composition of any one of embodiments (a)-(llll), wherein the oxide bonded to the cathode active material is a coating on the cathode active material.
(aaaaa) The composition of embodiment (zzzz), wherein the coating is continuous.
(bbbbb) The composition of embodiment (zzzz), wherein the coating is discontinuous. (ccccc) The composition of any one of embodiments (zzzz-(bbbbb) wherein the coating comprises crystalline domains as determined by TEM analysis.
(ddddd) The composition of any one of embodiments (zzzz)-(ccccc) wherein the coating comprises amorphous domains as determined by TEM analysis.
(eeeee) The composition of any one of embodiments (zzzz)-(ddddd), wherein the coating comprises crystalline domains and amorphous domains as determined by TEM analysis.
(fffff) The composition of embodiment (eeeee), wherein the crystalline domains are in contact with the cathode and the amorphous domains are in contact with the crystalline domains.
(ggggg) The composition of any one of embodiments (zzzz)-(fffff), wherein the coating has a thickness, T, as determined by TEM analysis, that is 0.7 nm≤T≤20 nm.
(hhhhh) The composition of any one of embodiments (zzzz)-(fffff), wherein the coating has a thickness, T, as determined by TEM analysis, that is 1 nm≤T≤20 nm.
(iiiii) The composition of any one of embodiments (zzzz)-(fffff), wherein the coating has a thickness, T, as determined by TEM analysis, that is less than 1 nm.
(jjjjj) The composition of embodiment (ggggg), wherein T is about 1 nm, about 5 nm, or about 10 nm.
(kkkkk) The composition of embodiment (ggggg), wherein T is between about 0.8 nm and 10 nm.
(lllll) The composition of embodiment (ggggg), wherein T is between about 0.8 nm and 5 nm.
(mmmmm) The composition of embodiment (ggggg), wherein T is between about 0.8 nm and 2.5 nm.
(nnnnn) The composition of any one of embodiments (eeeee)-(mmmmm) wherein the thickness of the crystalline domain is between about 0.8 nm and 5 nm and the thickness of the amorphous domain is between about 0.8 nm and 5 nm.
(ooooo) The composition of any one of embodiments (eeeee)-(mmmmm) wherein the thickness of the crystalline domain is between about 1 nm and 3 nm and the thickness of the amorphous domain is between about 1 nm and 4 nm.
(ppppp) The composition of any one of embodiments (eeeee)-(ooooo) wherein the thickness of the crystalline domain is less than the thickness of the amorphous domain.
(qqqqq) The composition of any one of any one of embodiments (zzzz)-(ppppp) wherein the coating is not thicker than the TEM can detect.
(rrrrr) The composition of any one of embodiments (zzzz)-(qqqqq), wherein the coating crystalline domains lattice match the crystalline domains of the cathode active material, as determined by TEM analysis.
(sssss) The composition of any one of embodiments (zzzz)-(qqqqq), wherein the coating crystalline domains do not lattice match the crystalline domains of the cathode active material, as determined by TEM analysis.
(ttttt) The composition of any one of embodiments (zzzz)-(sssss), wherein the coating further comprises carbonate.
(uuuuu) The composition of any one of embodiments (zzzz)-(ttttt), further comprising a second coating in contact with the coating.
(vvvvv) The composition of embodiment (uuuuu), wherein the second coating has a chemical formula which is not the same as the chemical formula of the coating.
(wwwww) The composition of embodiment (vvvvv), wherein the second coating has the chemical formula:
   LiₓZr_{y}O_{z}, wherein 0≤x≤1.6, 0.2≤y≤1.0, and 2≤z≤1.2;
   LiₓP_{y}O_{z}, wherein 0.6≤x≤1.5, 0.5≤y≤1.4, and 2.0≤z≤3.7;
   LiₓZr_{y}(PO₄)_{z}, wherein 0.05≤x≤1.5, 1≤y≤3, and 2.0≤z≤4.0;
   LiₓC_{y}O_{z}, wherein 0.4≤x≤1.8, 0.1≤y≤1, and 1≤z≤1.8;
   LiₓB_{y}O_{z}, wherein 0.2≤x≤0.75, 0.5≤y≤1.6, and 1.5≤z≤2.6;
   LiₓIn_{y}Cl_{z}, wherein 2≤x≤4, 0≤y≤2, and 5≤z≤7;
   LiₓZr_{y}(PO₄)_{z}, wherein 0.05≤x≤1.5, 1≤y≤3, and 2.0≤z≤4.0;
   Li₂CO₃; Li₃BO₃; Li₃B₁₁O₁₈; Li₂ZrO₃; Li₃PO₄; Li₂SO₄; LiNbO₃; Li₄Ti₅O₁₂; LiTi₂(PO₄)₃;
   LiZr₂(PO₄)₃; LiOH; LiF; Li₄ZrF₈; Li₃Zr₄F₁₉; Li₃TiF₆; LiAlF₄; LiYF₄; LiNbF₆; ZrO₂;
   Al₂O₃; TiO₂; ZrF₄; AlF₃; TiF₄; YF₃; NbF₅; and combinations thereof.
(xxxxx) A process for making a composition of any one of embodiments (a)-(llll), (wwww), and (zzzz)-(wwwww); comprising the following steps: 1) coating a cathode active material with a solution of a) LiOH and b) a zirconium precursor and/or a phosphorus precursor; 2) removing the solvent from the solution to provide a cathode active material bonded to the oxide of formula LiₓZr_{y}P_{A}O_{D}; and, 3) heating the cathode active material under dry air conditions to form a coated cathode active material.
(yyyyy) The process of embodiment (xxxxx), wherein the zirconium precursor is Zr(OBu)₄ and the phosphorus precursor is P₂O₅.
(zzzzz) The process of (xxxxx) and (yyyyy), wherein the heating is at a temperature of about 375° C. for about 1 hour.

### Process for Making

Set forth herein is a process for making a coated cathode active material wherein an oxide is selected from amorphous lithium zirconium oxide, amorphous lithium zirconium phosphorus oxide, and a combination thereof; comprising the following steps: 1) coating a cathode active material with a solution of a) LiOH and b) a zirconium precursor and/or a phosphorus precursor; 2) removing the solvent from the solution to provide a cathode active material bonded to the oxide selected from amorphous lithium zirconium oxide, amorphous lithium zirconium phosphorus oxide, and a combination thereof; and, 3) heating the cathode active material under dry air conditions to form a coated cathode active material.

Also set forth herein is a process for making a coated cathode active material wherein an oxide comprising a compound of the formula LiₓZr_{y}P_{A}O_{D} is bonded to the cathode active material, wherein 0.05≤x≤25.0, 0≤y≤5.0, 0≤a≤16.0; and 2.0≤d≤55.0 and wherein the formula is charge neutral; comprising the following steps: 1) coating a cathode active material with a solution of a) LiOH and b) a zirconium precursor and/or a phosphorus precursor; 2) removing the solvent from the solution to provide a cathode active material bonded to the oxide of formula LiₓZr_{y}P_{A}O_{D}; and, 3) heating the cathode active material under dry air conditions to form a coated cathode active material.

Also set forth herein is a process for making a coated cathode active material wherein an oxide comprising a compound of the formula LiₓZr_{y}P_{A}O_{D} is bonded to the cathode active material, wherein 0.5≤x≤7, 0≤y≤2, 0≤a≤3; and 2.0≤D≤20 and wherein the formula is charge neutral; comprising the following steps: 1) coating a cathode active material with a solution of a) LiOH and b) a zirconium precursor and/or a phosphorus precursor; 2) removing the solvent from the solution to provide a cathode active material bonded to the oxide of formula LiₓZr_{y}P_{A}O_{D}; and, 3) heating the cathode active material under dry air conditions to form a coated cathode active material.

In some examples, including any of the foregoing, the heating includes annealing in a controlled atmosphere. In some examples, that controlled atmosphere comprises Ar, N₂, H₂, H₂O or a combination thereof.

In one embodiment, including any of the foregoing, the phosphorus precursor is selected from P₂O₅, H₃PO₄, and (NH₄)₃PO₄, (NH₃)₃PO₄. In one embodiment, including any of the foregoing, the zirconium precursor is zirconium butoxide (Zr(OBu)₄), zirconium propoxide (Zr(OPr)₄), zirconium ethoxide (Zr(OEt)₄), and zirconium methoxide (Zr(OMe)₄). In one embodiment, including any of the foregoing, the lithium precursor is selected from lithium hydroxide (LiOH) lithium ethoxide (LiOEt), lithium methoxide (LiOMe), metallic lithium. In one embodiment, including any of the foregoing, the zirconium precursor and/or phosphorus precursor is a sol-gel precursor, such as a zirconium alkoxide or a phosphorus alkoxide precursor. In one embodiment, the phosphorus precursor is P₂O₅. In one embodiment, the zirconium precursor is Zr(OBu)₄. In one embodiment, the lithium precursor is LiOH.

In one embodiment, the zirconium precursor is Zr(OBu)₄, the phosphorus precursor is P₂O₅, and the lithium precursor is LiOH.

In certain embodiments, a source of LiOH includes, but is not limited to LiOH. In certain embodiments, a source of LiOH includes, but is not limited to a lithium-containing compound which is soluble in an alcohol, for example methanol or ethanol

In certain embodiments, including any of the foregoing, the heating is at a temperature of at most 350° C. for at least 10 minutes.

In certain embodiments, including any of the foregoing, the heating is at a temperature of at most 350° C. for at least 30 minutes.

In certain embodiments, including any of the foregoing, the heating is at a temperature of at most 375° C. for at least 30 minutes.

In certain embodiments, including any of the foregoing, the heating is at a temperature of about 375° C. for about 1 hour.

In certain embodiments, including any of the foregoing, the annealing is at a temperature of at most 350° C. for at least 10 minutes.

In certain embodiments, including any of the foregoing, the annealing is at a temperature of at most 350° C. for at least 30 minutes.

In certain embodiments, including any of the foregoing, the annealing is at a temperature of at most 375° C. for at least 30 minutes.

In certain embodiments, including any of the foregoing, the annealing is at a temperature of about 375° C. for about 1 hour.

In certain embodiments, including any of the foregoing, the solvent is an alcohol, including but not limited to, methanol or ethanol.

Additionally, the coated active materials can be formed using any suitable method for the formation of a coating on an active materials known in the art. Common techniques for the preparation of coated active materials include, but are not limited to, a wet process wherein a rotary evaporator is used to remove a solvent from a coating solution which includes active material particles; spray drying wherein a solution of coating precursors and active material is atomized through a spray nozzle by a flow of compressed gas and the resulting aerosol is dried; dry coating wherein solid powders of the coating precursors are combined with active materials to form a combination of the two; mechano fusion mixer in which high energy milling is used to coat an active material with a coating; and, atomic layer deposition (ALD), a vapor phase coating deposition technique; or a fluidized bed reactor. Other techniques for forming coated active materials include sputter deposition and laser ablation.

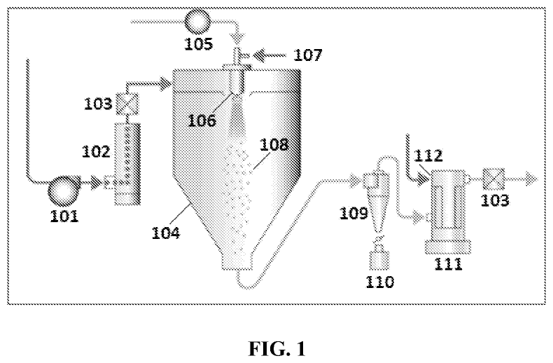

For example, one way to coat active materials is shown in FIG. 1. As shown in FIG. 1, a fan 101 is used to process air through a heater 102 and a HEPA filter 103. This processed air enters a drying chamber 104. The drying chamber is also connected to a feed pump 105. A liquid solution comprising active material and coating precursors is pumped through the feed pump 105 to the drying chamber 104 where it is atomized through a spray nozzle 106 using a carrier gas that is pumped into the drying chamber through inlet 107. The resulting droplets 108 are dried in the drying chamber 104. The dried material then passes into a cyclone 109 where the coated active materials are collected in vessel 110. The dry powder product is filtered through a Fines filter 111. In some examples, air pulses are used via input 112. The air is filtered through a second HEPA filter 103.

### EXAMPLES

Reagents, chemicals, and materials were commercially purchased unless specified otherwise to the contrary.

The Lithium Nickel Cobalt Manganese Oxide (NMC) used in the Examples was LiNi_{0.85}Co_{0.1}Mn_{0.05}O₂ unless specified otherwise.

### Example 1: Preparation of NMC with LZP Bonded to the Surface of the NMC

Six NMC cathode active materials with different LZP oxides attached thereto were prepared by the process described below. The starting material molar ratios for each synthesized oxide and the resulting molar ratio for each synthesized oxide are described in Table 1. The synthesis conditions, including the amount of each reagent and the reaction conditions are provided in Table 2 and Table 3.

TABLE 1
Starting Material and Molar Ratio LZP Coatings

| | | Starting Material Molar Ratio | | | Molar Ratio | | | |
|---|---|---|---|---|---|---|---|---|
| | | LiOH | Zr(OBu)₄ | P₂O₅ | Li | Zr | P | O |
| 1 | LiZr₂(PO₄)₃ | 22.22 | 44.44 | 33.34 | 1 | 2 | 3 | 12 |
| 2 | Li₃PO₄ | 85.71 | 0 | 14.29 | 3 | 0 | 1 | 4 |
| 3 | Li₂ZrO₃ | 66.67 | 33.33 | 0 | 2 | 1 | 0 | 3 |
| 4 | Li₃ZrPO₆ | 66.66 | 22.22 | 11.12 | 3 | 1 | 1 | 6 |
| 5 | Li₅PZrO₇ | 76.92 | 15.38 | 7.7 | 5 | 1 | 1 | 7 |
| 6 | Li₇ZrPO₈ | 82.35 | 11.76 | 5.89 | 7 | 1 | 1 | 8 |
| 7 | Li₂₄Zr₃P₁₄O₅₃ | 70.6 | 8.82 | 20.6 | 24 | 3 | 14 | 56 |

TABLE 2
Starting Material and Solvent Amounts

| | LiOH (g) | Zr(OBu)₄ (mL) | P₂O₅ (g) | Ethanol (g) | NMC (g) |
|---|---|---|---|---|---|
| 1 | 0.031 | 1.175 | 0.274 | 333 | 50 |
| 2 | 0.552 | 0 | 0.547 | 700 | 100 |
| 3 | 0.375 | 3.6 | 0 | 789 | 150 |
| 4 | 0.185 | 0.588 | 0.182 | 666 | 50 |
| 5 | 0.246 | 0.588 | 0.182 | 666 | 50 |
| 6 | 0.308 | 0.588 | 0.182 | 666 | 50 |
| 7 | 0.118 | 0.281 | 0.204 | 179 | 35 |

TABLE 3
Reaction Conditions

| | Stirring | Stirring | Drying | Annealing |
|---|---|---|---|---|
| | temperature | time | temperature | Temperature |
| | (° C) | (h) | (° C.) | (° C.) |
| 1 | 45 | 24 | 65 | 375 |
| 2 | 45 | 24 | 65 | 375 |
| 3 | 45 | 24 | 65 | 375 |
| 4 | 45 | 24 | 65 | 375 |
| 5 | 45 | 24 | 65 | 375 |
| 6 | 45 | 24 | 65 | 375 |
| 7 | 45 | 24 | 65 | 375 |

### Step 1: LZP Solution Preparation

A solution was prepared by placing LiOH (Spectrum Chemical), zirconium butoxide 80% solution (Sigma) and P₂O₅ (Sigma) in ethanol (Sigma). This mixture was stirred for 24 hours at 45° C. in an argon filled glovebox (H₂O<0.1 ppm, O₂<0.1 ppm). The amount of LiOH, zirconium butoxide 80% solution, and P₂O₅ is described in Table 1.

### Step 2: Coating Step

Lithium Nickel Cobalt Manganese Oxide (NMC) powder (purchased from BASF) was put into the solution prepared in step 1 and stirred for 24 hours. After stirring, the powder was dried using a rotary evaporator at 65° C. to remove the solution.

### Step 3: Annealing Step

The powder obtained from step 2 was heated under dry air at 375° C. for 1 hour under clean dry air (dew point<−80° C.). This resulted in the coated cathode material. Coated cathodes were stored under dry atmosphere (dp<−50° C.)

### Example 2: ICP (Inductively Coupled Plasma)

The elemental composition of the NMCs with coatings 1, 3, 4, 5, and 6 was analyzed by ICP-OES analysis using Perkin Elmer Optima 8000. Prior to the analysis, the samples were dissolved into solution by microwave digestion with a mixture of hydrochloric acid, sulfuric acid, and nitric acid. The results are shown in Table 4 and 5.

TABLE 4
ICP (wt %) Analysis of Li, Zr, P, Mn, Co, and Ni

| | | Li | Zr | P | Mn | Co | Ni |
|---|---|---|---|---|---|---|---|
| 1 | LiZr₂(PO₄)₃ | 7.466 | 0.542 | 0.265 | 2.573 | 6.018 | 51.47 |
| 3 | Li₂ZrO₃ | 7.46 | 0.363 | 0 | 2.67 | 6.04 | 51.8 |
| 4 | Li₃ZrPO₆ | 7.36 | 0.237 | 0.154 | 2.643 | 5.972 | 51.52 |
| 5 | Li₅PZrO₇ | 7.354 | 0.2 | 0.153 | 0.662 | 5.981 | 51.39 |
| 6 | Li₇ZrPO₈ | 7.45 | 0.216 | 0.156 | 2.655 | 6.008 | 51.55 |
| 7 | Li₂₄Zr₃P₁₄O₅₃ | 7.483 | 0.177 | 0.256 | 2.468 | 5.916 | 51.6 |

TABLE 5
ICP (wt %) Analysis of Mn + Co + Ni and P/Mn + Co + Ni

| | | Mn + Co + Ni | P/(Mn + Co + Ni) |
|---|---|---|---|
| 1 | LiZr₂(PO₄)₃ | 60.061 | 0.004412181 |
| 3 | Li₂ZrO₃ | 60.51 | 0 |
| 4 | Li₃ZrPO₆ | 60.135 | 0.002560905 |
| 5 | Li₅PZrO₇ | 58.033 | 0.002636431 |
| 6 | Li₇ZrPO₈ | 60.213 | 0.002590803 |
| 7 | Li₂₄Zr₃P₁₄O₅₃ | 59.984 | 0.004267805 |

### Example 3: XPS (X-Ray Photoelectron Spectroscopy)

NMCs with coatings 1, 3, 4, 5, and 6 were transferred to the XPS system (ThermoFisher Scientific K-Alpha) under dry atmosphere (−50° C.). XPS analysis was performed with Monochromated, Micro-focused Al—Ka as X-ray source at a pressure of 10⁻⁸ Torr. The diameter of the analyzed area was 400 mm.

The XPS spectra were fitted using Gaussian/Laurentzian product function peak shape model in combination with background. The results are shown in Table 6.

TABLE 6
XPS ANALYSIS
XPS (atomic %)

| | | Zr/Ni | C—CO₃/Ni | O-MeOₓ/O-total |
|---|---|---|---|---|
| 1 | LiZr₂(PO₄)₃ | 0.545 | 0.402 | 0.385 |
| 3 | Li₂ZrO₃ | 3.23 | 7.07 | 0.186 |
| 4 | Li₃ZrPO₆ | 1.2876 | 6.873984 | 0.080216 |
| 5 | Li₅PZrO₇ | 1.0663 | 8.259835 | 0.080494 |
| 6 | Li₇ZrPO₈ | 3.0429 | 17.24331 | 0.057046 |
| 7 | Li₂₄Zr₃P₁₄O₅₃ | 0.379 | 1.62 | 0.208 |

### Example 5: Area-Specific Resistance (ASR) Testing

A first solid electrolyte was prepared. Li₁₀Si_{0.5}Sn_{0.5}P₂S₁₂ (hereinafter “LSTPS”) was wet milled to produce LSTPS particles having a dso particle diameter of about 50 nm to 500 nm. See U.S. Pat. Nos. 9,172,114 and 10,535,878, which are herein incorporated by reference in their entirety for all purposes.

A second solid electrolyte was prepared: Lithium sulfide (Li₂S), phosphorus pentasulfide (P₂S₅), and lithium iodide (LiI) were mixed in a predetermined ratio. In one sample, lithium sulfide (Li₂S), phosphorus pentasulfide (P₂S₅), and lithium iodide (LiI) were mixed. The molar ratio of LiI:Li₂S:P₂S₅ was (3 to 4):(0.1 to 1):(0.5 to 1.5). The mixture was placed in a 500 mL zirconia milling jar with 1 mm zirconia milling media at a milling media:powder mass ratio of >7.5. The mixture was agitated in a planetary mill (Retsch PM400, 150 mm revolution radius, 1:2 speed ratio) for sixteen to thirty-six 16-32 hours.

This procedure was performed in an Ar filled glovebox (H₂O<0.1 ppm, O₂<0.1 ppm). Battery cell fabrication was performed in an Ar filled glovebox (H₂O<0.1 ppm, O₂<0.1 ppm).

A cathode layer was made by mixing the coated NMC material with the first solid electrolyte from above procedure.

An all-solid-state battery was made using a cathode layer mentioned in the preceding paragraph and a separator which was made of the second solid electrolyte.

The cathode layer and separator were pressed at 700 MPa to densify the two into a pellet type battery. An aluminum current collector was used adjacent to the cathode layer. A nickel current collector was used adjacent to an anode layer. Finally the stack of pellet and current collectors were vacuum sealed in Mylar bag to be a battery cell. The anode layer was made up of lithium metal. Metallic lithium as an anode was plated when the battery cell was charged.

Battery cells were charged and discharged at 30° C. at the intermittent current pulse with constant current density of 1.7 mA/cm² and within the operation voltage of 3 V to 4.25 V. The current pulse was applied for 9 minutes, the current was stopped, and the system was relaxed for 3 minutes. This intermittent pulse was repeated until the cell voltage reached to 4.25 V during charging and 3V during discharging. The area-specific resistance (ASR) of the battery cells was obtained by reading voltage drop during relaxation steps during discharging. The obtained ASR was named as R₁.

After cycling at 30° C., the battery cells were again charged to 4.25 V with a current density of 1.7 mA/cm². The temperature of the cells was then raised to 60° C. After the temperature stabilized at 60° C., the battery cells were held at 4.25 V for 7 days and the cells were discharged to 3 V.

The temperature of the battery cells was lowered to 30° C. The battery cells were charged and discharged between 3 V and 4.25 V and at a current density of 1.7 mA/cm². From this, an ASR (R₂) was determined.

The stability was evaluated by ΔR=R₂−R₁. The results are shown in Table 7.

TABLE 7
ASR MEASURMENT

| | | E testing (HVHT test) | | |
|---|---|---|---|---|
| | | Initial | ASR after 7 | Delta |
| | | ASR | days storage | ASR |
| | | (R¹) / Ω cm² | (R²) / Ω cm² | (ΔR) / Ω cm² |
| 1 | LiZr₂(PO₄)₃ | 26.945 | 33.944 | 7.78 |
| 2 | Li₃PO₄ | 19.96 | 21.35 | 1.39 |
| 3 | Li₂ZrO₃ | 35.548 | 45.128 | 9.58 |
| 4 | Li₃ZrPO₆ | 25.749 | — | — |
| 5 | Li₅PZrO₇ | 20.929 | 24.88 | 3.95 |
| 6 | Li₇ZrPO₈ | 22.097 | 24.401 | 2.3 |
| 7 | Li₂₄Zr₃P₁₄O₅₃ | 26 | 29.4 | 4.44 |

### Example 6: Li₂ZrO₃ Spray Coating

### Coating Solution Preparation

The precursor solution was prepared as followed: for every 1 L of ethanol, 0.375 g of lithium hydroxide (LiOH) was dissolved, and the mixture was stirred overnight. This was followed by an addition of 3.6 mL of zirconium butoxide ((Zr(OBu)₄), 80% solution) and the mixture was then stirred for 2 hours. This process was conducted in nitrogen or argon-filled glovebox (H₂O<0.1 ppm, O₂<0.1 ppm).

### Coating on Cathode Material

For every 1 L of ethanol, 150 g of lithium nickel manganese cobalt oxide (NMC) was added into the solution prepared in the above step and the mixture was stirred for 0.5 hour, followed by the addition of 0.425 mL of deionized water. The solution was then stirred for another 1.5 hours. This was done in a humidity-controlled environment (dew point<−50° C.).

### Spray Drying

BUCHI Mini Spray Dryer B-290/295 was used in the procedure described below.

First, the spray dryer was turned on and nozzle temp was set to 120-130° C. The B-295 chiller, associated with the spray dryer, was set to a temperature of −20° C. After warming up the tool to the set temperature, a small amount (˜50 mL) of ethanol was sprayed to clean the tool. This was followed by the solution, which was sprayed at around 45% of maximum peristaltic pump speed.

### Annealing

The obtained powder via the process described above was annealed under clean dry air at 375° C. for one hour.

### Example 7: LiZr₂(PO₄)₃ Spray Coating

### Coating Solution Preparation

For every 1 L of ethanol, the following was added in order, and the mixture was then stirred overnight in a nitrogen or argon-filled glovebox:
Lithium hydroxide (LiOH): 0.093 g
80% zirconium butoxide (Zr(OBu)₄): 3.525 mL
Phosphorous pentoxide (P₂O₅): 0.822 g

### Coating on Cathode Material

For every 1 L of ethanol, 150 g of lithium nickel manganese cobalt oxide (NMC) was added into the solution prepared in the above step and stirred for 1.5 hours. This was done in a humidity-controlled environment (dew point<−50° C.).

### Spray Drying

BUCHI Mini Spray Dryer B-290/295 was used in the procedure described below.

First, BUCHI B-290 was turned on and nozzle temp is set to 120-130° C. The B-295 chiller was set to a temperature of −20° C. After warming up the tool to the set temperature, a small amount (˜50 mL) of ethanol was sprayed to clean the tool. This was followed by the solution, which was sprayed at around 45% of maximum peristaltic pump speed.

### Annealing

The obtained powder via the process described above was annealed under clean dry air at 375° C. for one hour.

### Example 8: XPS (X-Ray Photoelectron Spectroscopy)

NMCs with coatings 1, 3, 4, 5, and 6 (as a loose powder) were transferred to the XPS system (ThermoFisher Scientific K-Alpha) under dry atmosphere (−50° C.).

The XPS measurements were carried out in an ultra-high vacuum (UHV) system Nexsa G2 (Thermo Fisher Scientific). The base pressure in the system was below 5×10⁻¹⁰ mbar. The XPS spectra were acquired with a hemispherical analyzer with pass energies 50 eV and 200 eV for high resolution and survey spectra, respectively. The XPS spectra were generated by an Al monochromated and a twin Al/Mg anode nonmonochromated X-ray sources operated at 12 keV and power 120 W. The scanned area diameter was 400 μm. Charge was compensated using Flood gun with current set at 100 μA.

XPS spectra were peak-fitted using Avantage (Thermo Fisher Scientific) data processing software using Gaussian/Laurentzian product function peak shape model in combination with background. For peak fitting Smart-type background subtraction was used. Quantification has been done using sensitivity factors provided by Avantage library.

The results are shown in Table 8.

TABLE 8
XPS ANALYSIS
XPS (atomic %)

| | | Zr/Ni min | Zr/Ni ave | Zr/Ni max |
|---|---|---|---|---|
| 1 | LiZr₂(PO₄)₃ | 0.1037 | 0.75 | 2.003 |
| 3 | Li₂ZrO₃ | 1.43 | 2.35 | 4.3 |
| 4 | Li₃ZrPO₆ | 0.168 | 1.367 | 2.12 |
| 5 | Li₅PZrO₇ | 0.12 | 1.0872 | 1.982 |
| 6 | Li₇ZrPO₈ | 0.1565 | 1.61447 | 3.143 |

### Example 9: TEM Analysis

An NMC coated with LiZr₂(PO₄)₃ was prepared for TEM measurements using Ga ion sourced focused ion beam (nanoDUE'T NB5000, Hitachi High-Technologies). To protect the surface of material from the Ga ion beam, multiple protective layers were deposited in advance to the sampling; at first, metal layer was deposited by plasma coater and then carbon protective layer and tungsten layer were deposited by high vacuum evaporation and focused ion beam, respectively. The thin slice sampling was conducted by focused ion beam. The prepared sample was measured in TEM.

TEM images of the LiZr₂(PO₄)₃-coated NMC were obtained by field emission electron microscope (JEM-2100F, JEOL). The Acceleration voltage was set to 200 kV. The electron beam radius was set to about 0.7 to 1 nm. FIGS. 2-6 are different particles of the same sample.

FIGS. 2-6 are TEM images of the LiZr₂(PO₄)₃-coated NMC. In FIG. 2, the coating has a thickness of about 2.0 nm to 2.5 nm, while in FIG. 3, the LiZr₂(PO₄)₃ coating is amorphous.

FIGS. 4 and 5 are TEM images of a LiZr₂(PO₄)₃-coated NMC where the LiZr₂(PO₄)₃ coating comprises crystalline domains and amorphous domains. In both images, the crystalline domain is at the interface of the cathode active material. In FIG. 4, the crystalline domain has a thickness between 1.5 and 2.5 nm, while the amorphous domain has a thickness of 3.4 nm.

FIG. 6 is a TEM image of a LiZr₂(PO₄)₃-coated NMC where the coating is discontinuous.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1-54. (canceled)

55. A composition comprising:
a cathode active material, wherein the cathode active material is LiNiₓMn_{y}Co_{z}O₂, x+y+z=1, 0≤x≤1, 0≤y≤1, and 0≤z≤1; and
at least one oxide bonded to the cathode active material, wherein the at least one oxide bonded to the cathode active material is a coating on the cathode active material;
wherein the at least one oxide bonded to the cathode active material comprises lithium (Li), oxygen (O), and at least one of zirconium (Zr) and phosphorus (P);
wherein the molar ratios of Li, Zr, P, and O, are represented by the formula 0.5≤x≤7.0, 1.0≤y≤3.0, 1.0≤a≤4.0, and 5.0≤d≤14.0;
wherein subscripts x, y, a, and d, are selected so the at least one oxide is charge neutral and y and a are not both zero;
wherein the composition has a ratio of Zr:Ni, as measured by x-ray photoelectron spectroscopy (XPS) of 0.3 to 3.2; and
wherein the composition comprises between about 5 weight % and 10 weight % of lithium as measured by inductively coupled plasma (ICP) analysis, less than about 1 weight % of zirconium as measured by inductively coupled plasma (ICP) analysis, less than about 0.5 weight % of phosphorus as measured by inductively coupled plasma (ICP) analysis, less than about 65 weight % of manganese, cobalt, and nickel as measured by inductively coupled plasma (ICP) analysis, or a combination thereof.

56. The composition of claim 55, wherein the at least one oxide bonded to the cathode active material is represented by the formula LiₓZr_{y}PₐO_{d}, wherein 1.0≤x≤2.0, 1.0≤y≤3.0, 2.0≤a≤4.0, and 11.0≤d≤13.0.

57. The composition of claim 55, wherein the at least one oxide is amorphous or crystalline.

58. The composition of claim 55, wherein the coated cathode active material comprises a second coating, wherein the second coating comprises LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; or a combination thereof.

59. The composition of claim 55, wherein the at least one oxide is lattice-matched with the cathode active material.

60. The composition of claim 55, wherein the cathode active material is
LiNiₓMn_{y}Co_{z}O₂, and either (a)-(h):
(a) x is 0.8, y is 0.1, and z is 0.1;
(b) x is 0.6, y is 0.2, and z is 0.2;
(c) x is 0.5, y is 0.3, and z is 0.2;
(d) x is ⅓, y is ⅓, and z is ⅓;
(e) 0.8≤x≤0.97, 0≤y≤0.2, and 0≤z≤0.2;
(f) 0.8≤x≤0.90, 0≤y≤0.2, and 0≤z≤0.2;
(g) 0.8≤x≤0.85, 0≤y≤0.2, and 0≤z≤0.2; or
(h) 0.8≤x≤0.83, 0≤y≤0.2, and 0≤z≤0.2

64. The composition of claim 55, characterized by an atomic percent ratio of Zr:Ni as determined by XPS between about 0.5 and 2.5.

65. The composition of claim 55, characterized by an atomic percent ratio of Zr:Ni of about 0.38, about 0.55, about 1.1, about 1.3, about 3.0, or about 3.2.

66. The composition of claim 55, wherein the coating on the cathode active material is continuous.

67. The composition of claim 55, wherein the coating on the cathode active material is discontinuous.

68. The composition of claim 55, wherein the coating on the cathode active material has a thickness, T, as determined by TEM analysis, that is between about 0.7 nm≤T≤20 nm.

69. The composition of claim 55, wherein the coating on the cathode active material comprises crystalline domains as determined by TEM analysis.

70. The composition of claim 55, wherein the coating on the cathode active material comprises amorphous domains as determined by TEM analysis.

71. The composition of claim 70, wherein the coating on the cathode active material comprises crystalline domains and amorphous domains as determined by TEM analysis and wherein the crystalline domains are in contact with the cathode and the amorphous domains are in contact with the crystalline domains.

72. The composition of claim 71, wherein thickness of the crystalline domain is between about 0.8 nm and 5 nm and the thickness of the amorphous domain is between about 0.8 nm and 5 nm.

73. A cathode comprising the composition of claim 55.

74. A process for making a composition of claim 55; comprising:
(1) coating a cathode active material with a solution of a) LiOH and b) a zirconium precursor and a phosphorus precursor;
(2) removing the solvent from the solution to provide a cathode active material bonded to the oxide; and
(3) heating the cathode active material under dry air conditions to form a coated cathode active material.
